(19) United States
(12) Patent Application Publication
(10) Pub. No.: US 2013/0083018 A1
(43) Pub. Date: Apr. 4, 2013

(54) PERSONAL AUDIO/VISUAL SYSTEM WITH HOLOGRAPHIC OBJECTS

(71) Applicants: Kevin A. Geisner, Mercer Island, WA (US); Stephen G. Latta, Seattle, WA (US); Ben J. Sugden, Woodinville, WA (US); Benjamin I. Vaught, Seattle, WA (US); Alex Aben-Athar Kipman, Redmond, WA (US); Kathryn Stone Perez, Kirkland, WA (US)

(72) Inventors: Kevin A. Geisner, Mercer Island, WA (US); Stephen G. Latta, Seattle, WA (US); Ben J. Sugden, Woodinville, WA (US); Benjamin I. Vaught, Seattle, WA (US); Alex Aben-Athar Kipman, Redmond, WA (US); Kathryn Stone Perez, Kirkland, WA (US)

(21) Appl. No.: 13/430,972

(22) Filed: Mar. 27, 2012

Related U.S. Application Data
(63) Continuation-in-part of application No. 13/250,878, filed on Sep. 30, 2011.

(51) Int. Cl. G06T 17/00; G09G 5/00

(52) U.S. Cl. 345/420; 345/633

(57) ABSTRACT

A system for generating an augmented reality environment using state-based virtual objects is described. A state-based virtual object may be associated with a plurality of different states. Each state of the plurality of different states may correspond with a unique set of triggering events different from those of any other state. The set of triggering events associated with a particular state may be used to determine when a state change from the particular state is required. In some cases, each state of the plurality of different states may be associated with a different 3-D model or shape. The plurality of different states may be defined using a predetermined and standardized file format that supports state-based virtual objects. In some embodiments, one or more potential state changes from a particular state may be predicted based on one or more triggering probabilities associated with the set of triggering events.

### CLAIM OF PRIORITY

The present application is a continuation-in-part of U.S. patent application Ser. No. 13/250,878, entitled “Personal Audio/Visual System,” filed Sep. 30, 2011, which is herein incorporated by reference in its entirety.

### BACKGROUND

Augmented reality (AR) relates to providing an augmented real-world environment where the perception of a real-world environment (or data representing a real-world environment) is augmented or modified with computer-generated virtual data. For example, data representing a real-world environment may be captured in real-time using sensory input devices such as a camera or microphone and augmented with computer-generated virtual data including virtual images and virtual sounds. The virtual data may also include information related to the real-world environment such as a text description associated with a real-world object in the real-world environment. An AR environment may be used to enhance numerous applications including video game, mapping, navigation, and mobile device applications.

Some AR environments enable the perception of real-time interaction between real objects (i.e., objects existing in a particular real-world environment) and virtual objects (i.e., objects that do not exist in the particular real-world environment). In order to realistically integrate the virtual objects into an AR environment, an AR system typically performs several steps including mapping and localization. Mapping relates to the process of generating a map of the real-world environment. Localization relates to the process of locating a particular point of view or pose relative to the map. A fundamental requirement of many AR systems is the ability to localize the pose of a mobile device moving within a real-world environment in order to determine the particular view associated with the mobile device that needs to be augmented over time.

### SUMMARY

Technology is described for generating an augmented reality environment using state-based virtual objects. A state-based virtual object may be associated with a plurality of different states. Each state of the plurality of different states may correspond with a unique set of triggering events different from those of any other state. The set of triggering events associated with a particular state may be used to determine when a state change from the particular state is required. In some cases, each state of the plurality of different states may be associated with a different 3-D model or shape. The plurality of different states may be defined using a predetermined and standardized file format that supports state-based virtual objects. In some embodiments, one or more potential state changes from a particular state may be predicted based on one or more triggering probabilities associated with the set of triggering events.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of one embodiment of a networked computing environment in which the disclosed technology may be practiced.

FIG. 2A depicts one embodiment of a mobile device in communication with a second mobile device.

FIG. 2B depicts one embodiment of a portion of an HMD.

FIG. 2C depicts one embodiment of a portion of an HMD in which gaze vectors extending to a point of gaze are used for aligning a far inter-pupillary distance (IPD).

FIG. 2D depicts one embodiment of a portion of an HMD in which gaze vectors extending to a point of gaze are used for aligning a near inter-pupillary distance (IPD).

FIG. 2E depicts one embodiment of a portion of an HMD with movable display optical systems including gaze detection elements.

FIG. 2F depicts an alternative embodiment of a portion of an HMD with movable display optical systems including gaze detection elements.

FIG. 2G depicts one embodiment of a side view of a portion of an HMD.

FIG. 2H depicts one embodiment of a side view of a portion of an HMD which provides support for a three dimensional adjustment of a microdisplay assembly.

FIG. 3A depicts one embodiment of an augmented reality environment as seen by an end user wearing an HMD.

FIG. 3B depicts one embodiment of an augmented reality environment as seen by an end user wearing an HMD.

FIG. 3C depicts one embodiment of an augmented reality environment.

FIGS. 3D-3E depict one embodiment of an augmented reality environment including state-based virtual objects.

FIG. 4 illustrates one embodiment of a computing system including a capture device and computing environment.

FIG. 5A depicts one embodiment of an AR system for providing virtual object information associated with a particular location or a particular place of interest.

FIG. 5B shows one example of a system architecture for executing one or more processes and/or software on a Supplemental Information Provider.

FIGS. 6A and 6B are flowcharts describing one set of processes for providing a personalized shopping experience using a personal A/V apparatus.

FIG. 7A depicts one embodiment of a virtual object file including virtual object information associated with one or more virtual objects.

FIG. 7B is a flowchart describing one embodiment of a process for generating an augmented reality environment.

FIG. 7C is a flowchart describing one embodiment of a process for predicting future virtual object states.

FIG. 7D is a flowchart describing one embodiment of a process for negotiating an information transfer with a supplemental information provider.

FIG. 7E is a flowchart describing one embodiment of a process for acquiring one or more virtual objects from a supplemental information provider.

FIG. 7F is a flowchart describing one embodiment of a process for acquiring one or more virtual objects.

FIG. 7G is a flowchart describing one embodiment of a process for displaying one or more virtual objects.

FIG. 8 is a block diagram of an embodiment of a gaming and media system.

FIG. 9 is a block diagram of one embodiment of a mobile device.

FIG. 10 is a block diagram of an embodiment of a computing system environment.

### DETAILED DESCRIPTION

Technology is described for generating a personalized augmented reality environment using a mobile device. The mobile device may display one or more images associated with a state-based virtual object such that the virtual object is perceived to exist within a real-world environment. A state-based virtual object may be associated with a plurality of different states. Each state of the plurality of different states may correspond with a unique set of triggering events different from those of any other state. The set of triggering events associated with a particular state may be used to determine when a state change from the particular state is required. In some cases, each state of the plurality of different states may be associated with a different 3-D model or shape. In other cases, each state of the plurality of different states may be associated with different virtual object properties (e.g., a virtual mass or a degree of virtual reflectivity). The plurality of different states may be defined using a predetermined and standardized file format that supports state-based virtual objects. In some embodiments, one or more potential state changes from a particular state may be predicted based on one or more triggering probabilities associated with the set of triggering events.

With the advent and proliferation of continuously-enabled and network-connected mobile computing devices, such as head-mounted display devices (HMDs), the amount of information available to an end user of such computing devices at any given time is immense. In some cases, an augmented reality environment may be perceived by an end user of a mobile computing device. In one example, the augmented reality environment may comprise a personalized augmented reality environment wherein one or more virtual objects are generated and displayed based on an identification of the end user, user preferences associated with the end user, the physical location of the end user, or environmental features associated with the physical location of the end user. In one embodiment, the one or more virtual objects may be acquired by the mobile computing device via a supplemental information provider. To allow for the efficient storage and exchange of virtual objects, the one or more virtual objects may be embodied within a predetermined and standardized file format. Each virtual object of the one or more virtual objects may be associated with a plurality of different states. The current state of a virtual object may be determined via a state diagram encoded within the predetermined and standardized file format.

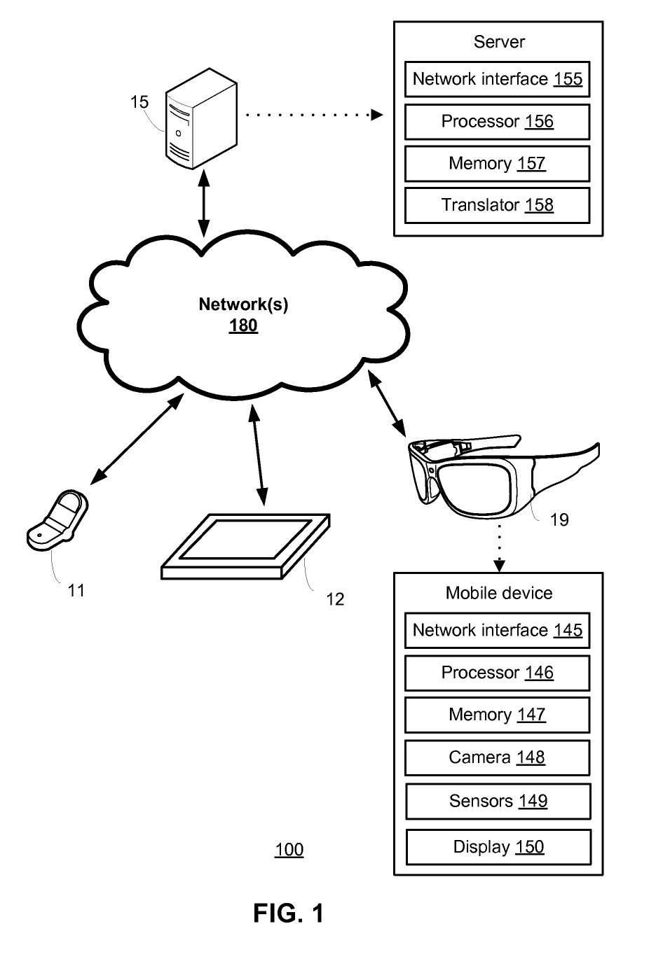

FIG. 1 is a block diagram of one embodiment of a networked computing environment 100 in which the disclosed technology may be practiced. Networked computing environment 100 includes a plurality of computing devices interconnected through one or more networks 180. The one or more networks 180 allow a particular computing device to connect to and communicate with another computing device. The depicted computing devices include mobile device 11, mobile device 12, mobile device 19, and server 15. In some embodiments, the plurality of computing devices may include other computing devices not shown. In some embodiments, the plurality of computing devices may include more than or less than the number of computing devices shown in FIG. 1. The one or more networks 180 may include a secure network such as an enterprise private network, an unsecure network such as a wireless open network, a local area network (LAN), a wide area network (WAN), and the Internet. Each network of the one or more networks 180 may include hubs, bridges, routers, switches, and wired transmission media such as a wired network or direct-wired connection.

Server 15, which may comprise a supplemental information server or an application server, may allow a client to download information (e.g., text, audio, image, and video files) from the server or to perform a search query related to particular information stored on the server. In general, a “server” may include a hardware device that acts as the host in a client-server relationship or a software process that shares a resource with or performs work for one or more clients. Communication between computing devices in a client-server relationship may be initiated by a client sending a request to the server asking for access to a particular resource or for particular work to be performed. The server may subsequently perform the actions requested and send a response back to the client.

One embodiment of server 15 includes a network interface 155, processor 156, memory 157, and translator 158, all in communication with each other. Network interface 155 allows server 15 to connect to one or more networks 180. Network interface 155 may include a wireless network interface, a modem, and/or a wired network interface. Processor 156 allows server 15 to execute computer readable instructions stored in memory 157 in order to perform processes discussed herein. Translator 158 may include mapping logic for translating a first file of a first file format into a corresponding second file of a second file format (i.e., the second file is a translated version of the first file). Translator 158 may be configured using file mapping instructions that provide instructions for mapping files of a first file format (or portions thereof) into corresponding files of a second file format.

One embodiment of mobile device 19 includes a network interface 145, processor 146, memory 147, camera 148, sensors 149, and display 150, all in communication with each other. Network interface 145 allows mobile device 19 to connect to one or more networks 180. Network interface 145 may include a wireless network interface, a modem, and/or a wired network interface. Processor 146 allows mobile device 19 to execute computer readable instructions stored in memory 147 in order to perform processes discussed herein. Camera 148 may capture color images and/or depth images. Sensors 149 may generate motion and/or orientation information associated with mobile device 19. Sensors 149 may comprise an inertial measurement unit (IMU). Display 150 may display digital images and/or videos. Display 150 may comprise a see-through display.

Networked computing environment 100 may provide a cloud computing environment for one or more computing devices. Cloud computing refers to Internet-based computing, wherein shared resources, software, and/or information are provided to one or more computing devices on-demand via the Internet (or other global network). The term “cloud” is used as a metaphor for the Internet, based on the cloud drawings used in computer networking diagrams to depict the Internet as an abstraction of the underlying infrastructure it represents.

In one example, mobile device 19 comprises a head-mounted display device (HMD) that provides an augmented reality environment or a mixed reality environment for an end user of the HMD. The HMD may comprise a video see-through and/or an optical see-through system. An optical see-through HMD worn by an end user may allow actual direct viewing of a real-world environment (e.g., via transparent lenses) and may, at the same time, project images of a virtual object into the visual field of the end user thereby augmenting the real-world environment perceived by the end user with the virtual object.

Utilizing the HMD, the end user may move around a real-world environment (e.g., a living room) wearing the HMD and perceive views of the real-world overlaid with images of virtual objects. The virtual objects may appear to maintain coherent spatial relationship with the real-world environment (i.e., as the end user turns their head or moves within the real-world environment, the images displayed to the end user will change such that the virtual objects appear to exist within the real-world environment as perceived by the end user). The virtual objects may also appear fixed with respect to the end user's point of view (e.g., a virtual menu that always appears in the top right corner of the end user's point of view regardless of how the end user turns their head or moves within the real-world environment). In one embodiment, environmental mapping of the real-world environment is performed by server 15 (i.e., on the server side) while camera localization is performed on mobile device 19 (i.e., on the client side). The virtual objects may include a text description associated with a real-world object. The virtual objects may also include virtual obstacles (e.g., non-movable virtual walls) and virtual targets (e.g., virtual monsters).

In some embodiments, a mobile device, such as mobile device 19, may be in communication with a server in the cloud, such as server 15, and may provide to the server location information (e.g., the location of the mobile device via GPS coordinates) and/or image information (e.g., information regarding objects detected within a field of view of the mobile device) associated with the mobile device. In response, the server may transmit to the mobile device one or more virtual objects based upon the location information and/or image information provided to the server. In one embodiment, the mobile device 19 may specify a particular file format for receiving the one or more virtual objects and server 15 may transmit to the mobile device 19 the one or more virtual objects embodied within a file of the particular file format.

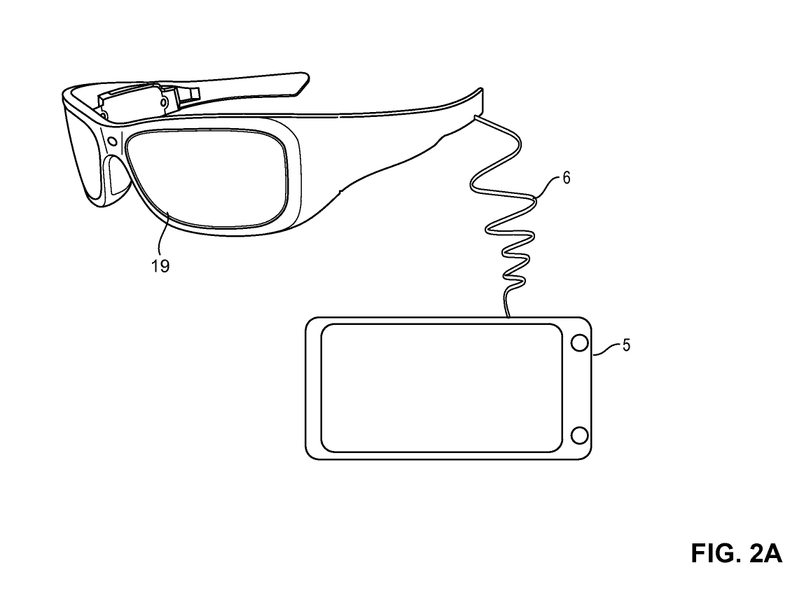

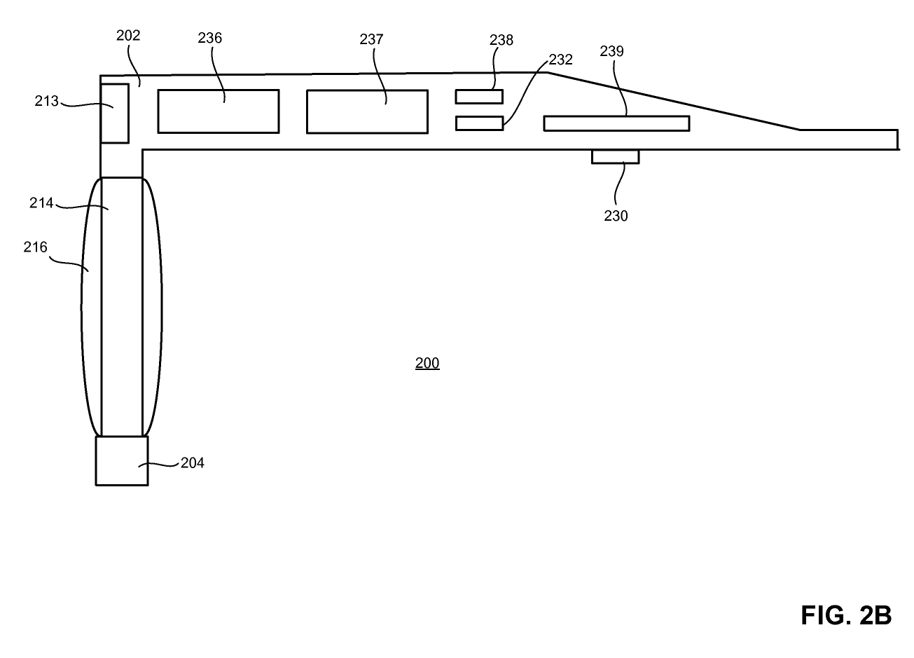

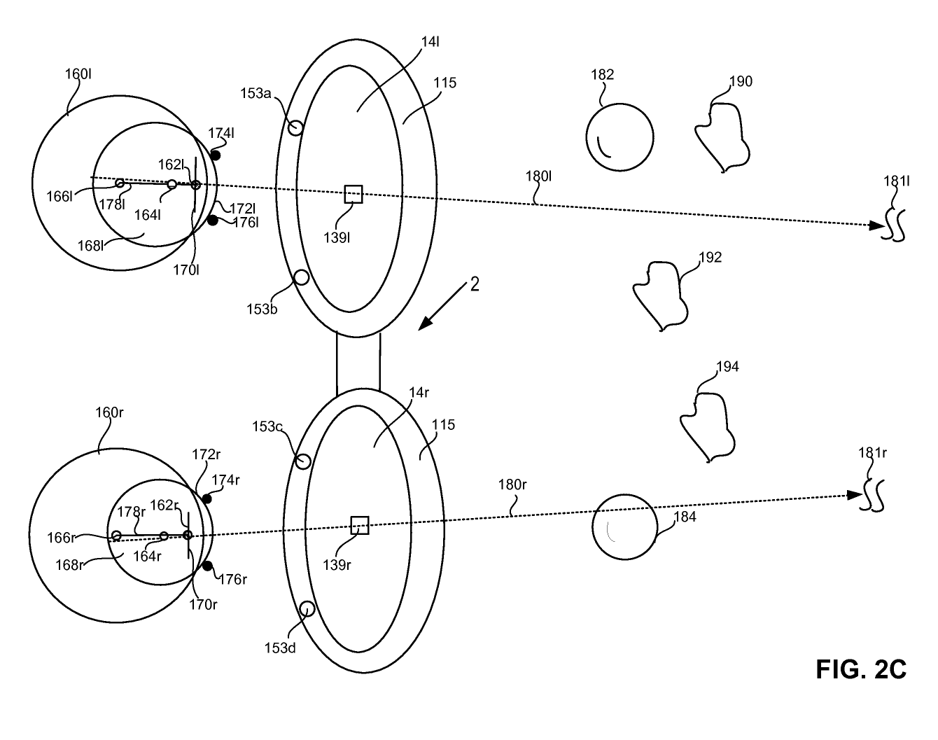

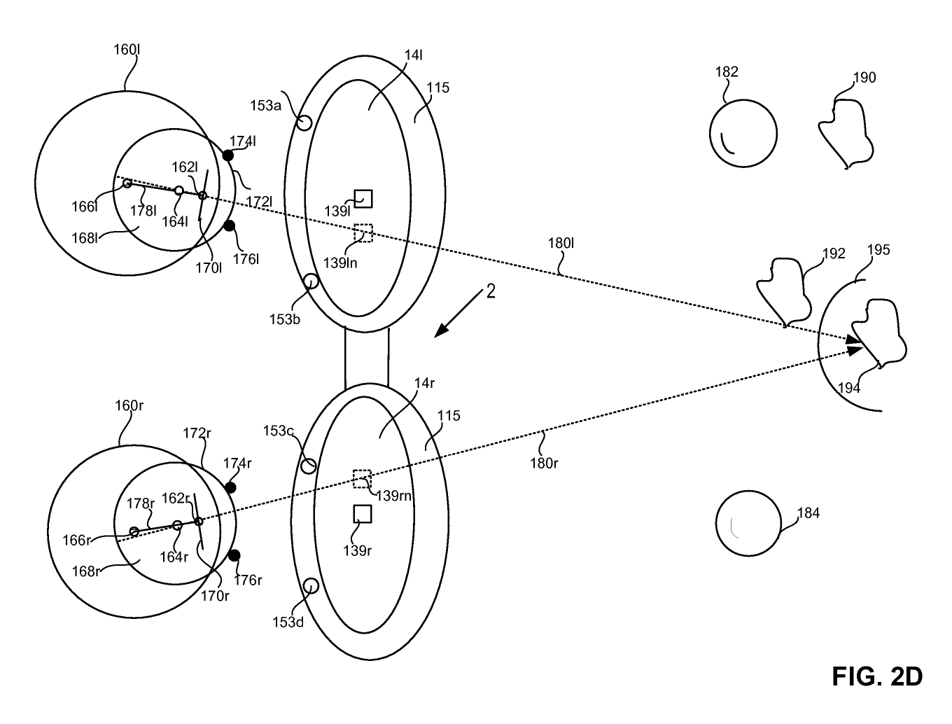

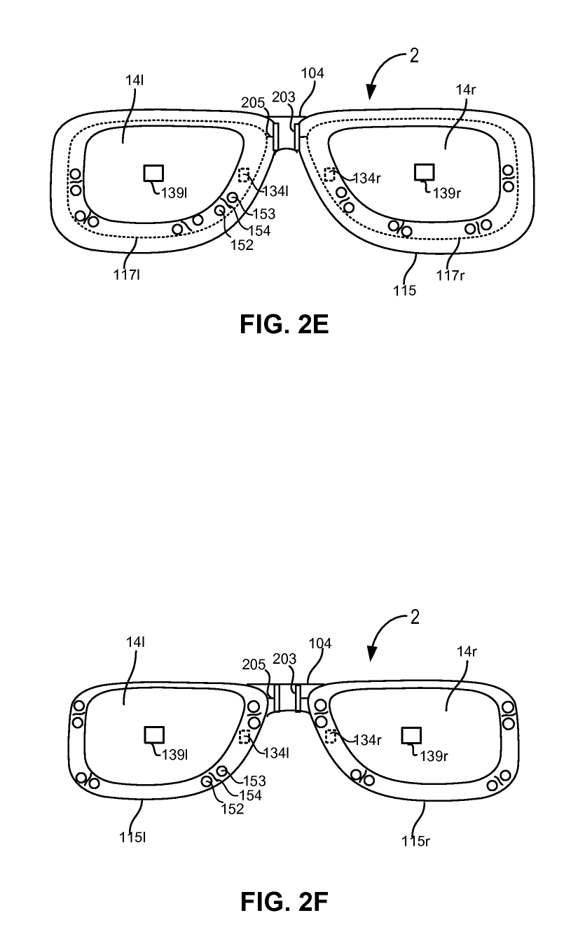

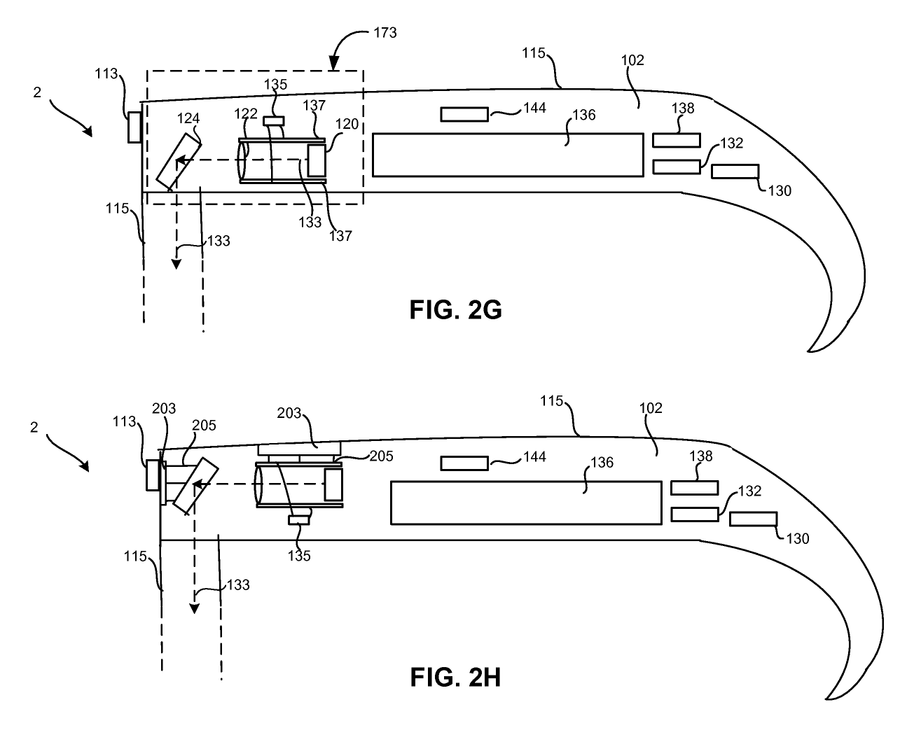

FIG. 2A depicts one embodiment of a mobile device 19 in communication with a second mobile device 5. Mobile device 19 may comprise a see-through HMD. As depicted, mobile device 19 communicates with mobile device 5 via a wired connection 6. However, the mobile device 19 may also communicate with mobile device 5 via a wireless connection. Mobile device 5 may be used by mobile device 19 in order to offload compute intensive processing tasks (e.g., the rendering of virtual objects) and to store virtual object information and other data necessary to provide an augmented reality environment on mobile device 19.

FIG. 2B depicts one embodiment of a portion of an HMD, such as mobile device 19 in FIG. 1. Only the right side of a head-mounted display device (HMD) 200 is depicted. HMD 200 includes right temple 202, nose bridge 204, eye glass 216, and eye glass frame 214. Right temple 202 includes a capture device 213 (e.g., a front facing camera and/or microphone) in communication with processing unit 236. The capture device 213 may include one or more cameras for recording digital images and/or videos and may transmit the visual recordings to processing unit 236. The one or more cameras may capture color information, IR information, and/or depth information. The capture device 213 may also include one or more microphones for recording sounds and may transmit the audio recordings to processing unit 236.

Right temple 202 also includes ear phones 230, motion and orientation sensor 238, GPS receiver 232, power supply 239, and wireless interface 237, all in communication with processing unit 236. Motion and orientation sensor 238 may include a three axis magnetometer, a three axis gyro, and/or a three axis accelerometer. In one embodiment, the motion and orientation sensor 238 may comprise an inertial measurement unit (IMU). The GPS receiver may determine a GPS location associated with HMD 200. Processing unit 236 may include one or more processors and a memory for storing computer readable instructions to be executed on the one or more processors. The memory may also store other types of data to be executed on the one or more processors.

In one embodiment, eye glass 216 may comprise a see-through display, whereby images generated by processing unit 236 may be projected and/or displayed on the see-through display. The capture device 213 may be calibrated such that a field of view captured by the capture device 213 corresponds with the field of view as seen by an end user of HMD 200. The ear phones 230 may be used to output sounds associated with the projected images of virtual objects. In some embodiments, HMD 200 may include two or more front facing cameras (e.g., one on each temple) in order to obtain depth from stereo information associated with the field of view captured by the front facing cameras. The two or more front facing cameras may also comprise 3-D, IR, and/or RGB cameras. Depth information may also be acquired from a single camera utilizing depth from motion techniques. For example, two images may be acquired from the single camera associated with two different points in space at different points in time. Parallax calculations may then be performed given position information regarding the two different points in space.

In some embodiments, HMD 200 may perform gaze detection for each eye of an end user's eyes using gaze detection elements and a three-dimensional coordinate system in relation to one or more human eye elements such as a cornea center, a center of eyeball rotation, or a pupil center. Examples of gaze detection elements may include glint generating illuminators and sensors for capturing data representing the generated glints. In some cases, the center of the cornea can be determined based on two glints using planar geometry. The center of the cornea links the pupil center and the center of rotation of the eyeball, which may be treated as a fixed location for determining an optical axis of the end user's eye at a certain gaze or viewing angle.

FIG. 2C depicts one embodiment of a portion of an HMD 2 in which gaze vectors extending to a point of gaze are used for aligning a far inter-pupillary distance (IPD). HMD 2 is one example of a mobile device, such as mobile device 19 in FIG. 1. As depicted, gaze vectors 180l and 180r intersect at a point of gaze that is far away from the end user (i.e., the gaze vectors 180l and 180r do not intersect as the end user is looking at an object far away). A model of the eyeball for eyeballs 160l and 160r is illustrated for each eye based on the Gullstrand schematic eye model. Each eyeball is modeled as a sphere with a center of rotation 166 and includes a cornea 168 modeled as a sphere having a center 164. The cornea 168 rotates with the eyeball, and the center of rotation 166 of the eyeball may be treated as a fixed point. The cornea 168 covers an iris 170 with a pupil 162 at its center. On the surface 172 of each cornea are glints 174 and 176.

As depicted in FIG. 2C, a sensor detection area 139 (i.e., 139l and 139r, respectively) is aligned with the optical axis of each display optical system 14 within an eyeglass frame 115. In one example, the sensor associated with the detection area may include one or more cameras capable of capturing image data representing glints 174l and 176l generated respectively by illuminators 153a and 153b on the left side of the frame 115 and data representing glints 174r and 176r generated respectively by illuminators 153c and 153d on the right side of the frame 115. Through the display optical systems 14l and 14r in the eyeglass frame 115, the end user's field of view includes both real objects 190, 192, and 194 and virtual objects 182 and 184.

The axis 178 formed from the center of rotation 166 through the cornea center 164 to the pupil 162 comprises the optical axis of the eye. A gaze vector 180 may also be referred to as the line of sight or visual axis which extends from the fovea through the center of the pupil 162. In some embodiments, the optical axis is determined and a small correction is determined through user calibration to obtain the visual axis which is selected as the gaze vector. For each end user, a virtual object may be displayed by the display device at each of a number of predetermined positions at different horizontal and vertical positions. An optical axis may be computed for each eye during display of the object at each position, and a ray modeled as extending from the position into the user's eye. A gaze offset angle with horizontal and vertical components may be determined based on how the optical axis must be moved to align with the modeled ray. From the different positions, an average gaze offset angle with horizontal or vertical components can be selected as the small correction to be applied to each computed optical axis. In some embodiments, only a horizontal component is used for the gaze offset angle correction.

As depicted in FIG. 2C, the gaze vectors 180l and 180r are not perfectly parallel as the vectors become closer together as they extend from the eyeball into the field of view at a point of gaze. At each display optical system 14, the gaze vector 180 appears to intersect the optical axis upon which the sensor detection area 139 is centered. In this configuration, the optical axes are aligned with the inter-pupillary distance (IPD). When an end user is looking straight ahead, the IPD measured is also referred to as the far IPD.

FIG. 2D depicts one embodiment of a portion of an HMD 2 in which gaze vectors extending to a point of gaze are used for aligning a near inter-pupillary distance (IPD). HMD 2 is one example of a mobile device, such as mobile device 19 in FIG. 1. As depicted, the cornea 168l of the left eye is rotated to the right or towards the end user's nose, and the cornea 168r of the right eye is rotated to the left or towards the end user's nose. Both pupils are gazing at a real object 194 within a particular distance of the end user. Gaze vectors 180l and 180r from each eye enter the Panum's fusional region 195 in which real object 194 is located. The Panum's fusional region is the area of single vision in a binocular viewing system like that of human vision. The intersection of the gaze vectors 180l and 180r indicates that the end user is looking at real object 194. At such a distance, as the eyeballs rotate inward, the distance between their pupils decreases to a near IPD. The near IPD is typically about 4 mm less than the far IPD. A near IPD distance criteria (e.g., a point of gaze at less than four feet from the end user) may be used to switch or adjust the IPD alignment of the display optical systems 14 to that of the near IPD. For the near IPD, each display optical system 14 may be moved toward the end user's nose so the optical axis, and detection area 139, moves toward the nose a few millimeters as represented by detection areas 139ln and 139rn.

More information about determining the IPD for an end user of an HMD and adjusting the display optical systems accordingly can be found in U.S. patent application Ser. No. 13/250,878, entitled “Personal Audio/Visual System,” filed Sep. 30, 2011, which is herein incorporated by reference in its entirety.

FIG. 2E depicts one embodiment of a portion of an HMD 2 with movable display optical systems including gaze detection elements. What appears as a lens for each eye represents a display optical system 14 for each eye (i.e., 14l and 14r). A display optical system includes a see-through lens and optical elements (e.g. mirrors, filters) for seamlessly fusing virtual content with the actual direct real world view seen through the lenses of the HMD. A display optical system 14 has an optical axis which is generally in the center of the see-through lens in which light is generally collimated to provide a distortionless view. For example, when an eye care professional fits an ordinary pair of eyeglasses to an end user's face, the glasses are usually fit such that they sit on the end user's nose at a position where each pupil is aligned with the center or optical axis of the respective lens resulting in generally collimated light reaching the end user's eye for a clear or distortionless view.

As depicted in FIG. 2E, a detection area 139r, 139l of at least one sensor is aligned with the optical axis of its respective display optical system 14r, 14l so that the center of the detection area 139r, 139l is capturing light along the optical axis. If the display optical system 14 is aligned with the end user's pupil, then each detection area 139 of the respective sensor 134 is aligned with the end user's pupil. Reflected light of the detection area 139 is transferred via one or more optical elements to the actual image sensor 134 of the camera, which in the embodiment depicted is illustrated by the dashed line as being inside the frame 115.

In one embodiment, the at least one sensor 134 may be a visible light camera (e.g., an RGB camera). In one example, an optical element or light directing element comprises a visible light reflecting mirror which is partially transmissive and partially reflective. The visible light camera provides image data of the pupil of the end user's eye, while IR photodetectors 152 capture glints which are reflections in the IR portion of the spectrum. If a visible light camera is used, reflections of virtual images may appear in the eye data captured by the camera. An image filtering technique may be used to remove the virtual image reflections if desired. An IR camera is not sensitive to the virtual image reflections on the eye.

In another embodiment, the at least one sensor 134 (i.e., 134l and 134r) is an IR camera or a position sensitive detector (PSD) to which the IR radiation may be directed. The IR radiation reflected from the eye may be from incident radiation of the illuminators 153, other IR illuminators (not shown), or from ambient IR radiation reflected off the eye. In some cases, sensor 134 may be a combination of an RGB and an IR camera, and the light directing elements may include a visible light reflecting or diverting element and an IR radiation reflecting or diverting element. In some cases, the sensor 134 may be embedded within a lens of the system 14. Additionally, an image filtering technique may be applied to blend the camera into a user field of view to lessen any distraction to the user.

As depicted in FIG. 2E, there are four sets of an illuminator 153 paired with a photodetector 152 and separated by a barrier 154 to avoid interference between the incident light generated by the illuminator 153 and the reflected light received at the photodetector 152. To avoid unnecessary clutter in the drawings, drawing numerals are shown with respect to a representative pair. Each illuminator may be an infra-red (IR) illuminator which generates a narrow beam of light at about a predetermined wavelength. Each of the photodetectors may be selected to capture light at about the predetermined wavelength. Infra-red may also include near-infrared. As there can be wavelength drift of an illuminator or photodetector or a small range about a wavelength may be acceptable, the illuminator and photodetector may have a tolerance range about a wavelength for generation and detection. In some embodiments where the sensor is an IR camera or IR position sensitive detector (PSD), the photodetectors may include additional data capture devices and may also be used to monitor the operation of the illuminators, e.g. wavelength drift, beam width changes, etc. The photodetectors may also provide glint data with a visible light camera as the sensor 134.

As depicted in FIG. 2E, each display optical system 14 and its arrangement of gaze detection elements facing each eye (e.g., such as camera 134 and its detection area 139, the illuminators 153, and photodetectors 152) are located on a movable inner frame portion 117l, 117r. In this example, a display adjustment mechanism comprises one or more motors 203 having a shaft 205 which attaches to the inner frame portion 117 which slides from left to right or vice versa within the frame 115 under the guidance and power of shafts 205 driven by motors 203. In some embodiments, one motor 203 may drive both inner frames.

FIG. 2F depicts an alternative embodiment of a portion of an HMD 2 with movable display optical systems including gaze detection elements. As depicted, each display optical system 14 is enclosed in a separate frame portion 115l, 115r. Each of the frame portions may be moved separately by the motors 203. More information about HMDs with movable display optical systems can be found in U.S. patent application Ser. No. 13/250,878, entitled “Personal Audio/Visual System,” filed Sep. 30, 2011, which is herein incorporated by reference in its entirety.

FIG. 2G depicts one embodiment of a side view of a portion of an HMD 2 including an eyeglass temple 102 of the frame 115. At the front of frame 115 is a front facing video camera 113 that can capture video and still images. In some embodiments, front facing camera 113 may include a depth camera as well as a visible light or RGB camera. In one example, the depth camera may include an IR illuminator transmitter and a hot reflecting surface like a hot mirror in front of the visible image sensor which lets the visible light pass and directs reflected IR radiation within a wavelength range or about a predetermined wavelength transmitted by the illuminator to a CCD or other type of depth sensor. Other types of visible light cameras (e.g., an RGB camera or image sensor) and depth cameras can be used. More information about depth cameras can be found in U.S. patent application Ser. No. 12/813,675, filed on Jun. 11, 2010, incorporated herein by reference in its entirety. The data from the cameras may be sent to control circuitry 136 for processing in order to identify objects through image segmentation and/or edge detection techniques.

Inside temple 102, or mounted to temple 102, are ear phones 130, inertial sensors 132, GPS transceiver 144, and temperature sensor 138. In one embodiment, inertial sensors 132 include a three axis magnetometer, three axis gyro, and three axis accelerometer. The inertial sensors are for sensing position, orientation, and sudden accelerations of HMD 2. From these movements, head position may also be determined.

In some cases, HMD 2 may include an image generation unit which can create one or more images including one or more virtual objects. In some embodiments, a microdisplay may be used as the image generation unit. As depicted, microdisplay assembly 173 comprises light processing elements and a variable focus adjuster 135. An example of a light processing element is a microdisplay unit 120. Other examples include one or more optical elements such as one or more lenses of a lens system 122 and one or more reflecting elements such as surfaces 124. Lens system 122 may comprise a single lens or a plurality of lenses.

Mounted to or inside temple 102, the microdisplay unit 120 includes an image source and generates an image of a virtual object. The microdisplay unit 120 is optically aligned with the lens system 122 and the reflecting surface 124. The optical alignment may be along an optical axis 133 or an optical path 133 including one or more optical axes. The microdisplay unit 120 projects the image of the virtual object through lens system 122, which may direct the image light onto reflecting element 124. The variable focus adjuster 135 changes the displacement between one or more light processing elements in the optical path of the microdisplay assembly or an optical power of an element in the microdisplay assembly. The optical power of a lens is defined as the reciprocal of its focal length (i.e., 1/focal length) so a change in one effects the other. The change in focal length results in a change in the region of the field of view which is in focus for an image generated by the microdisplay assembly 173.

In one example of the microdisplay assembly 173 making displacement changes, the displacement changes are guided within an armature 137 supporting at least one light processing element such as the lens system 122 and the microdisplay 120. The armature 137 helps stabilize the alignment along the optical path 133 during physical movement of the elements to achieve a selected displacement or optical power. In some examples, the adjuster 135 may move one or more optical elements such as a lens in lens system 122 within the armature 137. In other examples, the armature may have grooves or space in the area around a light processing element so it slides over the element, for example, microdisplay 120, without moving the light processing element. Another element in the armature such as the lens system 122 is attached so that the system 122 or a lens within slides or moves with the moving armature 137. The displacement range is typically on the order of a few millimeters (mm). In one example, the range is 1-2 mm. In other examples, the armature 137 may provide support to the lens system 122 for focal adjustment techniques involving adjustment of other physical parameters than displacement. An example of such a parameter is polarization.

More information about adjusting a focal distance of a microdisplay assembly can be found in U.S. patent Ser. No. 12/941,825 entitled “Automatic Variable Virtual Focus for Augmented Reality Displays,” filed Nov. 8, 2010, which is herein incorporated by reference in its entirety.

In one embodiment, the adjuster 135 may be an actuator such as a piezoelectric motor. Other technologies for the actuator may also be used and some examples of such technologies are a voice coil formed of a coil and a permanent magnet, a magnetostriction element, and an electrostriction element.

Several different image generation technologies may be used to implement microdisplay 120. In one example, microdisplay 120 can be implemented using a transmissive projection technology where the light source is modulated by optically active material and backlit with white light. These technologies are usually implemented using LCD type displays with powerful backlights and high optical energy densities. Microdisplay 120 can also be implemented using a reflective technology for which external light is reflected and modulated by an optically active material. The illumination may be forward lit by either a white source or RGB source, depending on the technology. Digital light processing (DLP), liquid crystal on silicon (LCOS) and Mirasol® display technology from Qualcomm, Inc. are all examples of reflective technologies which are efficient as most energy is reflected away from the modulated structure and may be used in the system described herein. Additionally, microdisplay 120 can be implemented using an emissive technology where light is generated by the display. For example, a PicoP™ engine from Microvision, Inc. emits a laser signal with a micro mirror steering either onto a tiny screen that acts as a transmissive element or beamed directly into the eye (e.g., laser).

FIG. 2H depicts one embodiment of a side view of a portion of an HMD 2 which provides support for a three dimensional adjustment of a microdisplay assembly. Some of the numerals illustrated in the FIG. 2G above have been removed to avoid clutter in the drawing. In some embodiments where the display optical system 14 is moved in any of three dimensions, the optical elements represented by reflecting surface 124 and the other elements of the microdisplay assembly 173 may also be moved for maintaining the optical path 133 of the light of a virtual image to the display optical system. An XYZ transport mechanism in this example made up of one or more motors represented by motor block 203 and shafts 205 under control of control circuitry 136 control movement of the elements of the microdisplay assembly 173. An example of motors which may be used are piezoelectric motors. In the illustrated example, one motor is attached to the armature 137 and moves the variable focus adjuster 135 as well, and another representative motor 203 controls the movement of the reflecting element 124.

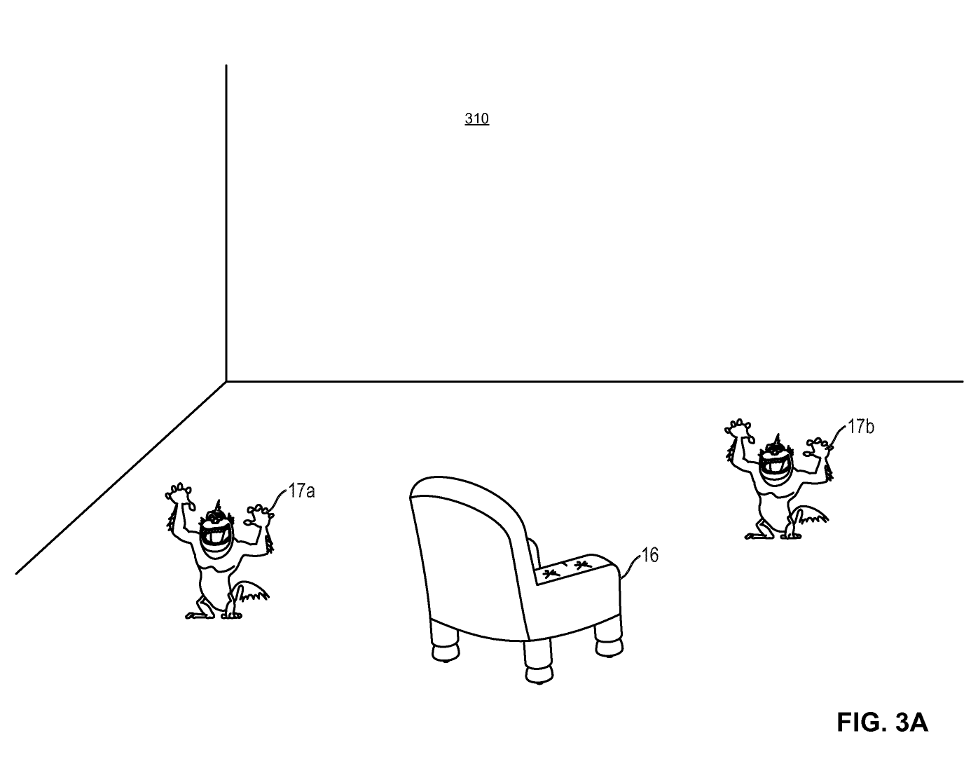

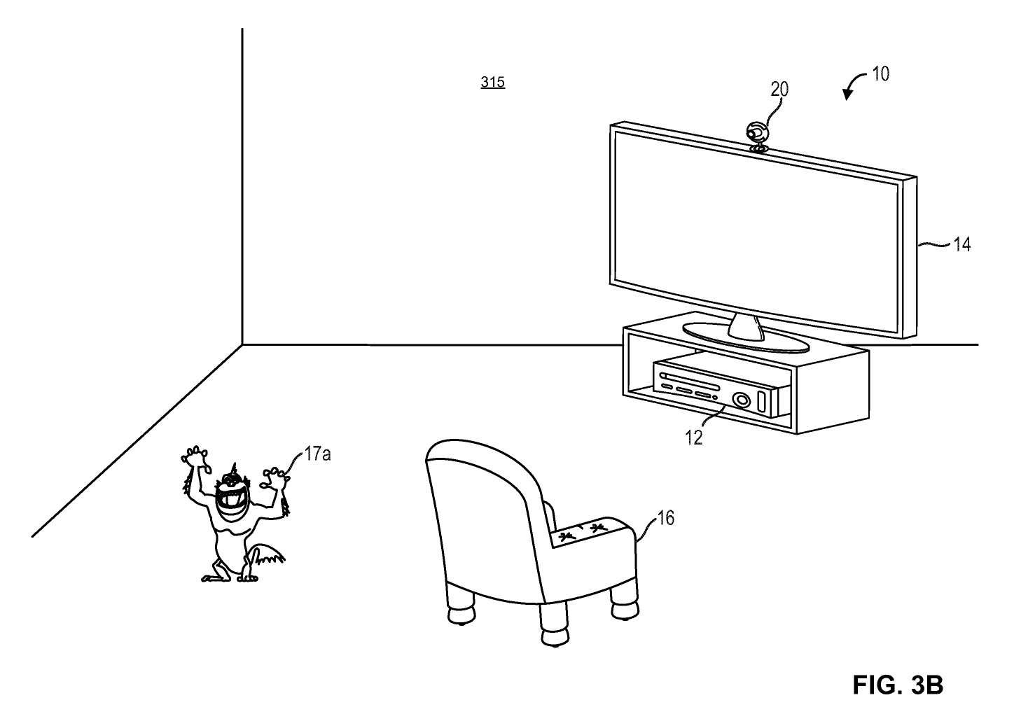

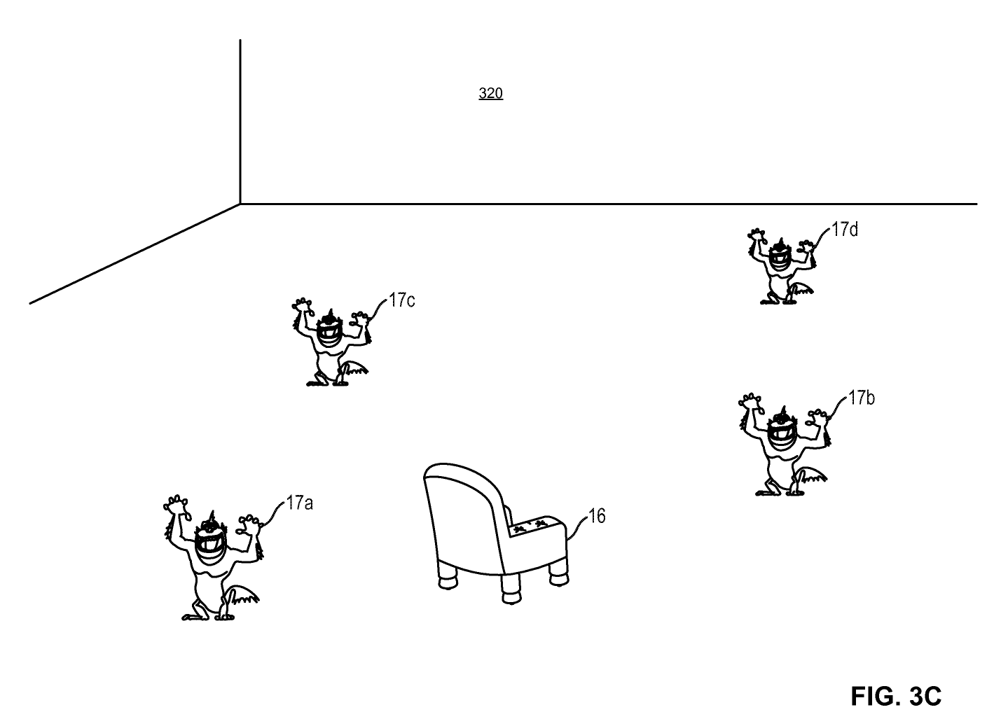

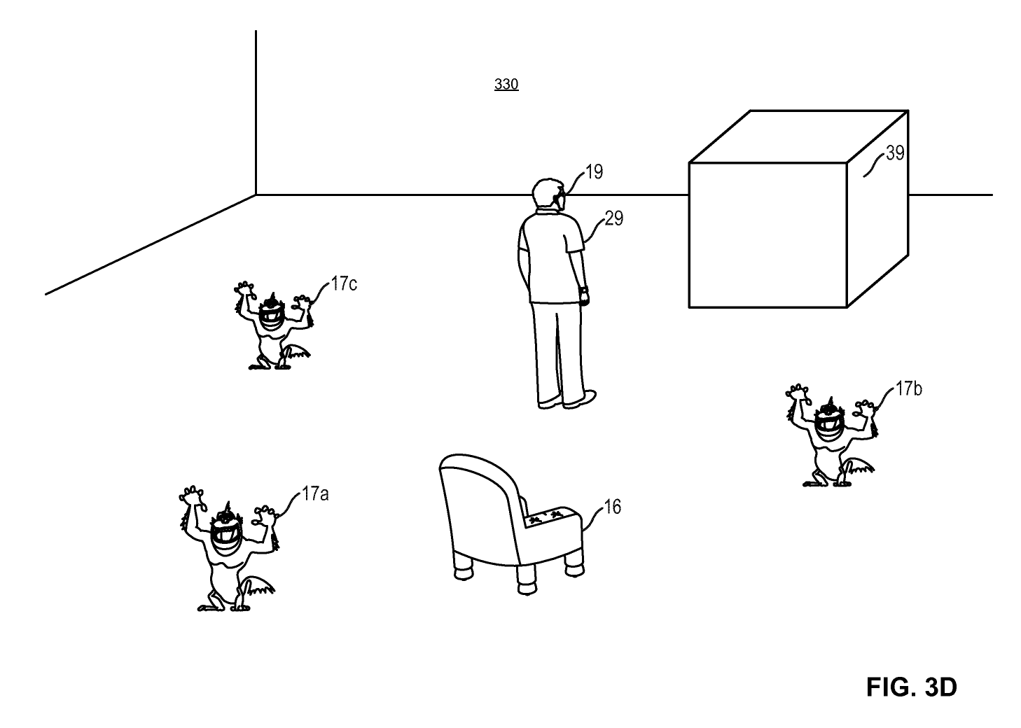

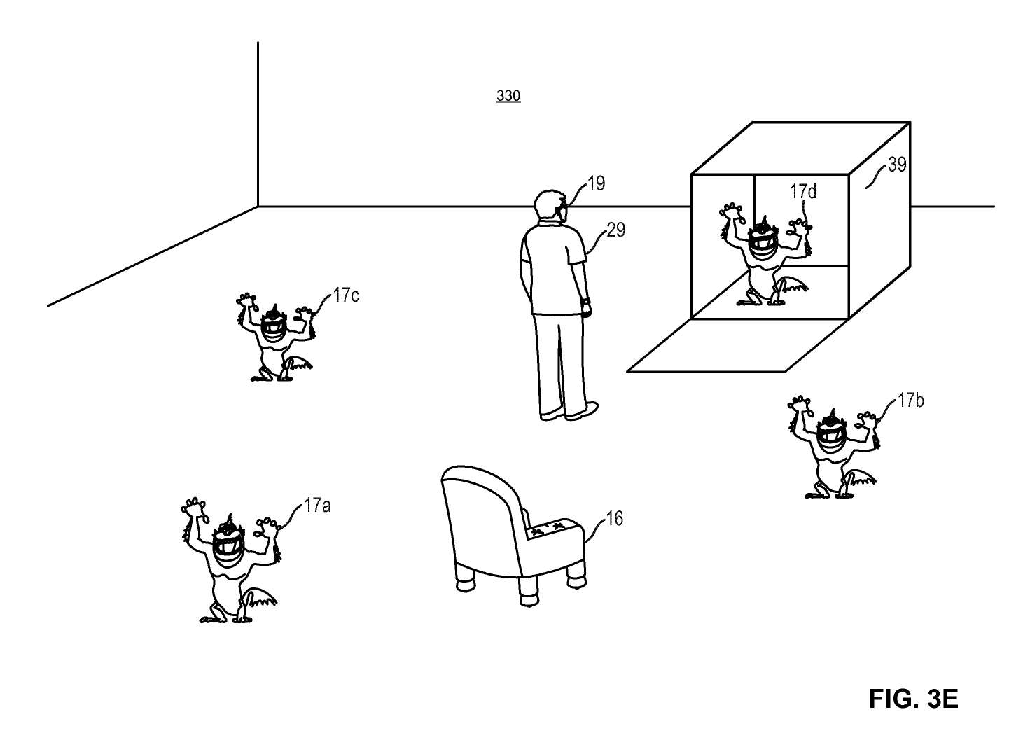

FIGS. 3A-3E provide examples of various augmented reality environments in which one or more virtual objects are generated or adapted based on environmental features identified within various real-world environments. In some embodiments, the one or more virtual objects may include state-based virtual objects.

FIG. 3A depicts one embodiment of an augmented reality environment 310 as seen by an end user wearing an HMD, such as mobile device 19 in FIG. 1. The end user may view both real objects and virtual objects. The real objects may include a chair 16. The virtual objects may include virtual monsters 17a-b. As the virtual monsters 17a-b are displayed or overlaid over the real-world environment as perceived through the see-through lenses of the HMD, the end user of the HMD may perceive that the virtual monsters 17a-b exist within the real-world environment.

FIG. 3B depicts one embodiment of an augmented reality environment 315 as seen by an end user wearing an HMD, such as mobile device 19 in FIG. 1. The end user may view real objects and virtual objects. The real objects may include a chair 16 and a computing system 10. The virtual objects may include a virtual monster 17a. The computing system 10 may include a computing environment 12, a capture device 20, and a display 14, all in communication with each other. Computing environment 12 may include one or more processors. Capture device 20 may include one or more color or depth sensing cameras that may be used to visually monitor one or more targets including humans and one or more other real objects within a particular real-world environment. Capture device 20 may also include a microphone. In one example, capture device 20 may include a depth sensing camera and a microphone and computing environment 12 may comprise a gaming console. The computing system 10 may support multiple mobile devices or clients by providing them with virtual objects and/or mapping information regarding the real-world environment.

In some embodiments, the computing system 10 may track and analyze virtual objects within the augmented reality environment 315. The computing system 10 may also track and analyze real objects within the real-world environment corresponding with augmented reality environment 315. The rendering of images associated with virtual objects, such as virtual monster 17a, may be performed by computing system 10 or by the HMD. The computing system 10 may also provide 3-D maps associated with augmented reality environment 315 to the HMD.

In one embodiment, the computing system 10 may map the real-world environment associated with the augmented reality environment 315 (e.g., by generating a 3-D map of the real-world environment), and track both real objects and virtual objects within the augmented reality environment 315 in real-time. In one example, the computing system 10 provides virtual object information for a particular store (e.g., a clothing store or car dealership). Before an end user of an HMD enters the particular store, computing system 10 may have already generated a 3-D map including the static real-world objects inside the particular store. When the end user enters the particular store, the computing system 10 may begin tracking dynamic real-world objects and virtual objects within the augmented reality environment 315. The real-world objects moving within the real-world environment (including the end user) may be detected and classified using edge detection and pattern recognition techniques. The computing system may determine interactions between the real-world objects and the virtual objects and provide images of the virtual objects to the HMD for viewing by the end user as the end user walks around the particular store. In some embodiments, a 3-D map of the real-world environment including the static real-world objects inside the particular store may be transmitted to the HMD along with one or more virtual objects for use inside the particular store. The HMD may then determine interactions between real-world objects and the one or more virtual objects within the particular store and generate the augmented reality environment 315 locally on the HMD.

FIG. 3C depicts one embodiment of an augmented reality environment 320. The end user may view both real objects and virtual objects. The real objects may include a chair 16. The virtual objects may include virtual monsters 17a-d. As the virtual monsters 17a-d are displayed or overlaid over the real-world environment as perceived through the see-through lenses of the HMD, the end user of the HMD may perceive that the virtual monsters 17a-d exist within the real-world environment.

As depicted, the real-world environment associated with augmented reality environment 320 includes more open space compared with the real-world environment associated with augmented reality environment 310 in FIG. 3A. In some cases, in order to achieve a particular degree of difficulty associated with a gaming application, the larger amount of open space may require a greater number of virtual monsters to appear within augmented reality environment 320 (e.g., dodging four virtual monsters moving within a large real-world area may be deemed as difficult as dodging two virtual monsters within a smaller real-world area). However, in other gaming applications, a larger amount of open space may correspond with a more difficult gaming environment. More information about augmented reality environments with adaptive game rules can be found in U.S. patent application Ser. No. 13/288,350, entitled “Augmented Reality Playspaces With Adaptive Game Rules,” filed Nov. 3, 2011, which is herein incorporated by reference in its entirety.

FIGS. 3D-3E depict one embodiment of an augmented reality environment 330 including state-based virtual objects. As depicted, the end user 29 of an HMD 19 may view both real objects and virtual objects. The real objects may include a chair 16. The virtual objects may include virtual monsters 17a-c and a state-based virtual object comprising virtual box 39. As the virtual objects are displayed or overlaid over the real-world environment as perceived through the see-through lenses of the HMD 19, the end user of the HMD 19 may perceive that the virtual objects exist within the real-world environment.

In one embodiment, end user 29 may view a state-based virtual object comprising virtual box 39. In a first state depicted in FIG. 3D, the virtual box appears to be closed. By staring at the virtual box 39 for a particular period of time and/or performing a particular physical gesture (e.g., a particular hand gesture), the virtual box 39 may transition from the first state depicted in FIG. 3D into a second state depicted in FIG. 3E. Once the virtual box 39 is set into the second state, the object's shape and/or other properties may be altered. As depicted, the virtual box 39 appears to be opened and a new virtual object (i.e., virtual monster 17d) is generated and displayed as existing within the augmented reality environment 330. In one example, in order to close the virtual box 39, the end user 29 may have to perform a different physical gesture than the particular physical gesture used to open the virtual box and/or issue a particular voice command. In some embodiments, the second state may correspond with a different 3-D model of the virtual object than the 3-D model associated with the first state (e.g., the second state may be associated with a deformed version of the virtual object in the first state).

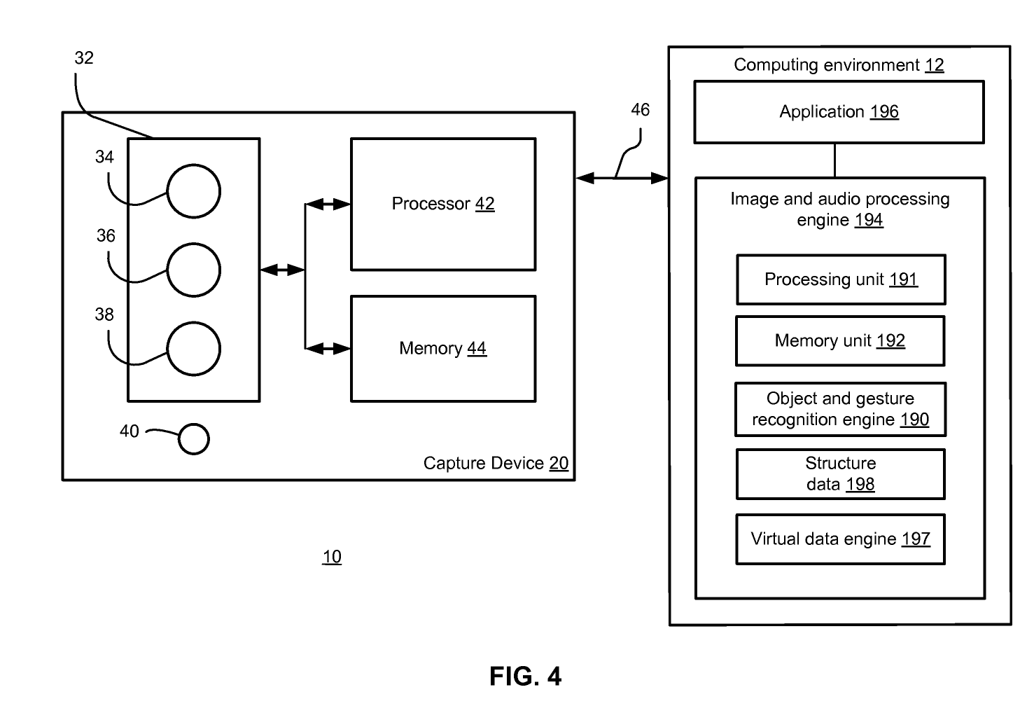

FIG. 4 illustrates one embodiment of a computing system 10 including a capture device 20 and computing environment 12. In some embodiments, capture device 20 and computing environment 12 may be integrated within a single computing device. The single computing device may comprise a mobile device, such as mobile device 19 in FIG. 1. In some cases, the capture device 20 and computing environment 12 may be integrated within an HMD.

In one embodiment, the capture device 20 may include one or more image sensors for capturing images and videos. An image sensor may comprise a CCD image sensor or a CMOS image sensor. In some embodiments, capture device 20 may include an IR CMOS image sensor. The capture device 20 may also include a depth sensor (or depth sensing camera) configured to capture video with depth information including a depth image that may include depth values via any suitable technique including, for example, time-of-flight, structured light, stereo image, or the like.

The capture device 20 may include an image camera component 32. In one embodiment, the image camera component 32 may include a depth camera that may capture a depth image of a scene. The depth image may include a two-dimensional (2-D) pixel area of the captured scene where each pixel in the 2-D pixel area may represent a depth value such as a distance in, for example, centimeters, millimeters, or the like of an object in the captured scene from the image camera component 32.

The image camera component 32 may include an IR light component 34, a three-dimensional (3-D) camera 36, and an RGB camera 38 that may be used to capture the depth image of a capture area. For example, in time-of-flight analysis, the IR light component 34 of the capture device 20 may emit an infrared light onto the capture area and may then use sensors to detect the backscattered light from the surface of one or more objects in the capture area using, for example, the 3-D camera 36 and/or the RGB camera 38. In some embodiments, pulsed infrared light may be used such that the time between an outgoing light pulse and a corresponding incoming light pulse may be measured and used to determine a physical distance from the capture device 20 to a particular location on the one or more objects in the capture area. Additionally, the phase of the outgoing light wave may be compared to the phase of the incoming light wave to determine a phase shift. The phase shift may then be used to determine a physical distance from the capture device to a particular location associated with the one or more objects.

In another example, the capture device 20 may use structured light to capture depth information. In such an analysis, patterned light (i.e., light displayed as a known pattern such as grid pattern or a stripe pattern) may be projected onto the capture area via, for example, the IR light component 34. Upon striking the surface of one or more objects (or targets) in the capture area, the pattern may become deformed in response. Such a deformation of the pattern may be captured by, for example, the 3-D camera 36 and/or the RGB camera 38 and analyzed to determine a physical distance from the capture device to a particular location on the one or more objects. Capture device 20 may include optics for producing collimated light. In some embodiments, a laser projector may be used to create a structured light pattern. The light projector may include a laser, laser diode, and/or LED.

In some embodiments, two or more different cameras may be incorporated into an integrated capture device. For example, a depth camera and a video camera (e.g., an RGB video camera) may be incorporated into a common capture device. In some embodiments, two or more separate capture devices of the same or differing types may be cooperatively used. For example, a depth camera and a separate video camera may be used, two video cameras may be used, two depth cameras may be used, two RGB cameras may be used, or any combination and number of cameras may be used. In one embodiment, the capture device 20 may include two or more physically separated cameras that may view a capture area from different angles to obtain visual stereo data that may be resolved to generate depth information. Depth may also be determined by capturing images using a plurality of detectors that may be monochromatic, infrared, RGB, or any other type of detector and performing a parallax calculation. Other types of depth image sensors can also be used to create a depth image.

As depicted in FIG. 4, capture device 20 may include one or more microphones 40. Each of the one or more microphones 40 may include a transducer or sensor that may receive and convert sound into an electrical signal. The one or more microphones may comprise a microphone array in which the one or more microphones may be arranged in a predetermined layout.

The capture device 20 may include a processor 42 that may be in operative communication with the image camera component 32. The processor may include a standardized processor, a specialized processor, a microprocessor, or the like. The processor 42 may execute instructions that may include instructions for storing filters or profiles, receiving and analyzing images, determining whether a particular situation has occurred, or any other suitable instructions. It is to be understood that at least some image analysis and/or target analysis and tracking operations may be executed by processors contained within one or more capture devices such as capture device 20.

The capture device 20 may include a memory 44 that may store the instructions that may be executed by the processor 42, images or frames of images captured by the 3-D camera or RGB camera, filters or profiles, or any other suitable information, images, or the like. In one example, the memory 44 may include random access memory (RAM), read only memory (ROM), cache, Flash memory, a hard disk, or any other suitable storage component. As depicted, the memory 44 may be a separate component in communication with the image capture component 32 and the processor 42. In another embodiment, the memory 44 may be integrated into the processor 42 and/or the image capture component 32. In other embodiments, some or all of the components 32, 34, 36, 38, 40, 42 and 44 of the capture device 20 may be housed in a single housing.

The capture device 20 may be in communication with the computing environment 12 via a communication link 46. The communication link 46 may be a wired connection including, for example, a USB connection, a FireWire connection, an Ethernet cable connection, or the like and/or a wireless connection such as a wireless 802.11b, g, a, or n connection. The computing environment 12 may provide a clock to the capture device 20 that may be used to determine when to capture, for example, a scene via the communication link 46. In one embodiment, the capture device 20 may provide the images captured by, for example, the 3-D camera 36 and/or the RGB camera 38 to the computing environment 12 via the communication link 46.

As depicted in FIG. 4, computing environment 12 includes image and audio processing engine 194 in communication with application 196. Application 196 may comprise an operating system application or other computing application such as a gaming application. Image and audio processing engine 194 includes virtual data engine 197, object and gesture recognition engine 190, structure data 198, processing unit 191, and memory unit 192, all in communication with each other. Image and audio processing engine 194 processes video, image, and audio data received from capture device 20. To assist in the detection and/or tracking of objects, image and audio processing engine 194 may utilize structure data 198 and object and gesture recognition engine 190. Virtual data engine 197 processes virtual objects and registers the position and orientation of virtual objects in relation to various maps of a real-world environment stored in memory unit 192.

Processing unit 191 may include one or more processors for executing object, facial, and voice recognition algorithms. In one embodiment, image and audio processing engine 194 may apply object recognition and facial recognition techniques to image or video data. For example, object recognition may be used to detect particular objects (e.g., soccer balls, cars, people, or landmarks) and facial recognition may be used to detect the face of a particular person. Image and audio processing engine 194 may apply audio and voice recognition techniques to audio data. For example, audio recognition may be used to detect a particular sound. The particular faces, voices, sounds, and objects to be detected may be stored in one or more memories contained in memory unit 192. Processing unit 191 may execute computer readable instructions stored in memory unit 192 in order to perform processes discussed herein.

The image and audio processing engine 194 may utilize structural data 198 while performing object recognition. Structure data 198 may include structural information about targets and/or objects to be tracked. For example, a skeletal model of a human may be stored to help recognize body parts. In another example, structure data 198 may include structural information regarding one or more inanimate objects in order to help recognize the one or more inanimate objects.

The image and audio processing engine 194 may also utilize object and gesture recognition engine 190 while performing gesture recognition. In one example, object and gesture recognition engine 190 may include a collection of gesture filters, each comprising information concerning a gesture that may be performed by a skeletal model. The object and gesture recognition engine 190 may compare the data captured by capture device 20 in the form of the skeletal model and movements associated with it to the gesture filters in a gesture library to identify when a user (as represented by the skeletal model) has performed one or more gestures. In one example, image and audio processing engine 194 may use the object and gesture recognition engine 190 to help interpret movements of a skeletal model and to detect the performance of a particular gesture.

In some embodiments, one or more objects being tracked may be augmented with one or more markers such as an IR retroreflective marker to improve object detection and/or tracking. Planar reference images, coded AR markers, QR codes, and/or bar codes may also be used to improve object detection and/or tracking. Upon detection of one or more objects and/or gestures, image and audio processing engine 194 may report to application 196 an identification of each object or gesture detected and a corresponding position and/or orientation if applicable.

More information about detecting and tracking objects can be found in U.S. patent application Ser. No. 12/641,788, “Motion Detection Using Depth Images,” filed on Dec. 18, 2009; and U.S. patent application Ser. No. 12/475,308, “Device for Identifying and Tracking Multiple Humans over Time,” both of which are incorporated herein by reference in their entirety. More information about object and gesture recognition engine 190 can be found in U.S. patent application Ser. No. 12/422,661, “Gesture Recognizer System Architecture,” filed on Apr. 13, 2009, incorporated herein by reference in its entirety. More information about recognizing gestures can be found in U.S. patent application Ser. No. 12/391,150, “Standard Gestures,” filed on Feb. 23,2009; and U.S. patent application Ser. No. 12/474,655, “Gesture Tool,” filed on May 29, 2009, both of which are incorporated by reference herein in their entirety.

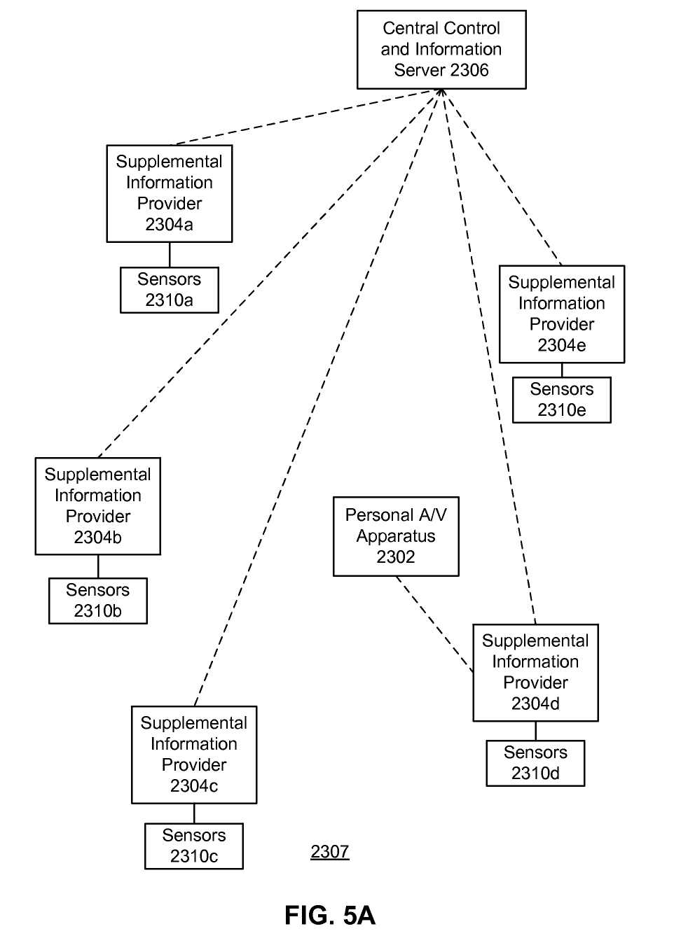

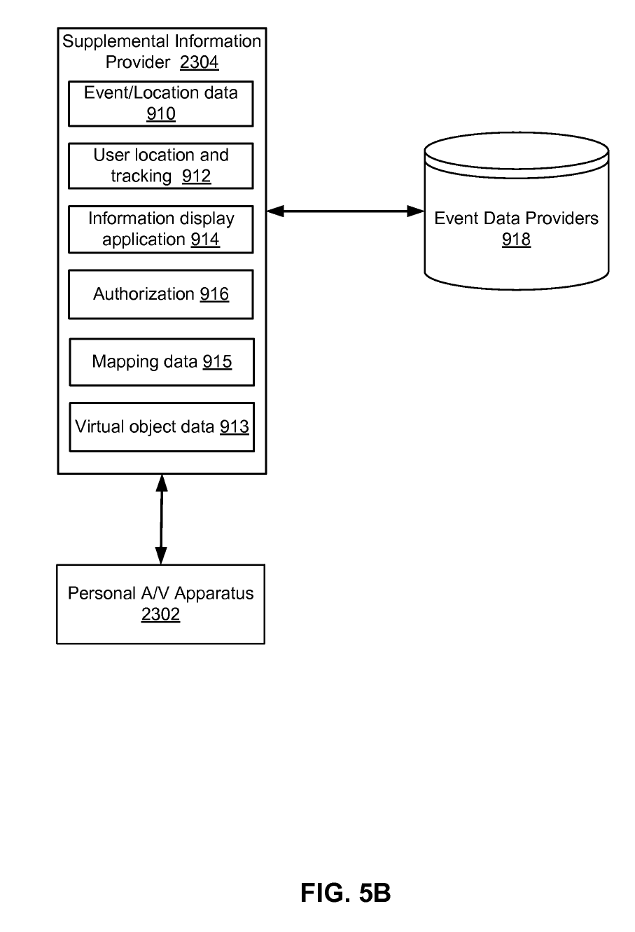

FIG. 5A depicts one embodiment of an AR system 2307 for providing virtual object information associated with a particular location or a particular place of interest. A particular place of interest may include a department store, a furniture store, a car dealership, an amusement park, a museum, a zoo, or a person's work or residence. The virtual object information may include 3-D maps of an environment and/or one or more virtual objects associated with an environment. To allow for the efficient storage and exchange of virtual objects, the one or more virtual objects may be transmitted using a predetermined and standardized file format.

AR system 2307 includes a personal A/V apparatus 2302 (e.g., an HMD such as mobile device 19 in FIG. 1) in communication with one of the Supplemental Information Providers 2304a-e. Supplemental Information Providers 2304a-e are in communication with a Central Control and Information Server 2306, which may include one or more computing devices. Each Supplemental Information Provider 2304 may be co-located with and in communication with one of one or more sensors 2310a-e. The sensors may include video sensors, depth image sensors, heat sensors, IR sensors, weight sensors, and motion sensors. In some embodiments, a Supplemental Information Provider may not be paired with any sensors.

Each of the Supplemental Information Providers may be placed at various locations throughout a particular place of interest. The Supplemental Information Providers may provide virtual object information or 3-D maps associated with a particular area within the particular place of interest. The sensors 2310 may acquire information regarding different subsections of the particular place of interest. For example, in the case of an amusement park, a Supplemental Information Provider 2304 and an accompanying set of one or more sensors 2310 may be placed at each ride or attraction in the amusement park. In the case of a museum, a Supplemental Information Provider 2304 may be located in each section or room of the museum, or in each major exhibit. The sensors 2310 may be used to determine the amount of people waiting on line for a ride (or exhibit) or how crowded the ride (or exhibit) is.

In one embodiment, AR system 2307 may provide to an end user of personal A/V apparatus 2302 directions on how to navigate through the place of interest. Additionally, Central Control and Information Server 2306, based on the information from the sensors 2310 can indicate which areas of the place of interest are less crowded. In the case of an amusement park, the system can tell the end user of personal A/V apparatus 2302 which ride has the shortest line. In the case of a ski mountain, the AR system 2307 can provide the end user of personal A/V apparatus 2302 with an indication of which lift line is the shortest or which trail is the less crowded. The personal A/V apparatus 2302 may move around the place of interest with the end user and may establish connections with the closest Supplemental Information Provider 2304 at any given time.

FIG. 5B shows one example of a system architecture for executing one or more processes and/or software on a Supplemental Information Provider 2304, such as Supplemental Information Provider 2304a in FIG. 5A. Supplemental Information Provider 2304 may create and provide supplemental event or location data, or may provide services which transmit event or location data from third party event data providers 918 to an end user's personal A/V apparatus 2302. Multiple supplemental information providers and third party event data providers may be utilized with the present technology.

Supplemental Information Provider 2304 may include supplemental data for one or more events or locations for which the service is utilized. Event and/or location data can include supplemental event and location data 910 about one or more events known to occur within specific periods of time and/or about one or more locations that provide a customized experience. User location and tracking module 912 keeps track of various users which are utilizing the system. Users can be identified by unique user identifiers, location, and/or other identifying elements. An information display application 914 allows customization of both the type of display information to be provided to end users and the manner in which it is displayed. The information display application 914 can be utilized in conjunction with an information display application on the personal A/V apparatus 2302. In one embodiment, the display processing occurs at the Supplemental Information Provider 2304. In alternative embodiments, information is provided to personal A/V apparatus 2302 so that personal A/V apparatus 2302 determines which information should be displayed and where, within the display, the information should be located. Authorization application 916 may authenticate a particular personal A/V apparatus prior to transmitting supplemental information to the particular personal A/V apparatus.

Supplemental Information Provider 2304 also includes mapping data 915 and virtual object data 913. Mapping data 915 may include 3-D maps associated with one or more real-world environments. Virtual object data 913 may include one or more virtual objects associated with the one or more real-world environments for which mapping data is available. In some embodiments, the one or more virtual objects may be defined using a predetermined and standardized file format that supports state-based virtual objects.

Various types of information display applications can be utilized in accordance with the present technology. Different applications can be provided for different events and locations. Different providers may provide different applications for the same live event. Applications may be segregated based on the amount of information provided, the amount of interaction allowed or other feature. Applications can provide different types of experiences within the event or location, and different applications can compete for the ability to provide information to users during the same event or at the same location. Application processing can be split between the supplemental information provider 2304 and the personal A/V apparatus 902.

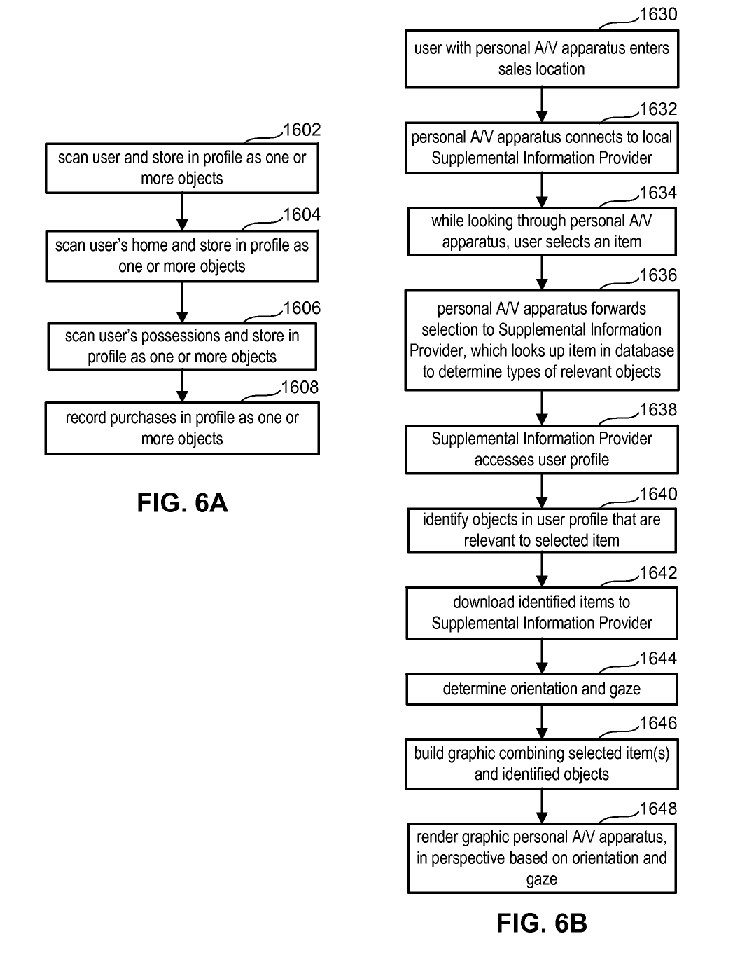

FIGS. 6A and 6B are flowcharts describing one set of processes for providing a personalized shopping experience using a personal A/V apparatus, such as personal A/V apparatus 2302 in FIG. 5A. The process of FIG. 6A is used to set up the system so that the personalized shopping experience can be provided when a user enters a particular business or sales location. In step 1602 of FIG. 6A, the user will be scanned. Example of scanning a user can include taking still pictures, video images and/or depth images of the user. The system can also access a profile for that user with the user's previous scan and details. The images may be used to create information about the user's physical appearance. In other embodiments, the user can manually enter in various measurements. The information for the user is stored in the user's profile as one or more objects. In step 1604, the user's home is scanned using still images, video images, and/or depth images. Information about the user's home is stored in the user's profile as one or more objects. In step 1606, the user's possessions are scanned using still images, video images, and/or depth images. The information scanned is stored in the user's profile as one or more objects. In step 1608, any purchase the user makes will result in the information about the purchased item being stored in the user's profile as one or more objects. In one embodiment, it is not necessary to scan additional purchases because the information about the purchased item will already be in a database of a manufacturer or a retailer and can be loaded from the database into the user's profile directly. In one embodiment, the user profile is stored by a server, such as Central Control and Information Server 2306 in FIG. 5A.

FIG. 6B describes one embodiment of a process for providing a personalized shopping experience. In step 1630, a user with a personal A/V apparatus enters a sales location. In step 1632, the personal A/V apparatus connects to a local Supplemental Information Provider. In step 1634, the user will select an item at the sales location while looking through the personal A/V apparatus. In one embodiment, the user can select the item by saying the name of the item, pointing to the item, touching the item, or using a particular gesture. Other means for selecting an item utilizing the one or more microphones, video cameras, and/or depth cameras onboard the personal A/V apparatus may be used to sense what the user is selecting.

In step 1636, the personal A/V apparatus will forward the selection to the local Supplemental Information Provider, which is at the sales location. The Supplemental Information Provider will look up the selected item in a database to determine the types of virtual objects that are relevant to that item. In one embodiment, the database is local to the Supplemental Information Provider. In another embodiment, the Supplemental Information Provider will access the database through the Internet or other network. In one example, each sales location (e.g., a store in a mall) might have its own server or a mall might have a global server that is shared across all stores in the mall.

In step 1638, the Supplemental Information Provider will access the user profile. In one embodiment, the user profile is stored on a server, such as Central Control and Information Server 2306 of FIG. 5A. In step 1640, either a Supplemental Information Provider or a Central Control and Information Server will identify those objects in the user profile that are relevant to the item based on the information obtained in step 1636. The objects in the user profile that are relevant to the selected item are downloaded in step 1642.

In step 1644, the personal A/V apparatus will determine its orientation using onboard sensors. The A/V apparatus will also determine the gaze of the user. In step 1646, the personal A/V apparatus, or a Supplemental Information Provider, will build a graphic that combines images of the selected item and the identified objects from the user profile. In one embodiment, only one item is selected. In other embodiments, multiple items can be selected and the graphic could include the multiple items as well as the multiple identified objects. In step 1648, the graphic that combines the images of the selected items and the identified objects is rendered on the personal A/V apparatus, in perspective based on the determined orientation and gaze. In some embodiments, the user may see through the personal A/V apparatus to view the selected item and the objects will be automatically added to the field of view of the user.

One example implementation of the process of FIG. 6B includes a user viewing a home for sale. The selected item may be one of the rooms in the home or maybe the home itself. The objects from the user's profile will be the user's furniture. When the user walks through the home (which presumably is empty), the user's furniture (i.e., the user's objects in the user profile that are tagged or otherwise identified as the user's furniture) will be projected in the personal A/V apparatus so that the user will see the user's furniture in the home.

Another example implementation of FIG. 6B includes the user visiting a furniture store. The selected items can be one or more pieces of furniture in the furniture store. The objects obtained from the user's profile will be the rooms in the user's house and furniture in the user's house. For example, if the user is shopping for a couch, the selected item may be one or more couches. The personal A/V apparatus will depict an image of the user's living room with the selected couch projected in that living so the user can see what the couch would look like in their living room. In some cases, virtual object information associated with the one or more pieces of furniture in the furniture store that were selected by the end user may be stored for future reference. At home, the user may load and view one or more virtual objects associated with the one or more pieces of furniture for sale at the furniture store while viewing their living room.

In one embodiment, the system can be used to enhance shopping for clothing. When a user sees an item of clothing the user is interested in, the personal A/V system can project an image of the user wearing that item. Alternatively, the user can look in a mirror to see the himself/herself wearing the item of interest. In that case, the personal A/V system will project an image of the article of clothing on the user in the reflection of the mirror. These examples show how a user can look through a see-through personal A/V apparatus (e.g., mobile device 19 in FIG. 1), and images can be projected in the user's field of view such that these projected images combined with the real world viewed through the personal A/V apparatus create a personalized experience for the user.

In another embodiment, the system is used to customize in-store displays based on what a user is interested in. For example, the window models all switch out to be wearing the items that a user is interested in. Consider the example where a user is shopping for a black dress so every store she walks by has all black dresses displayed virtually onto the mannequins in their front displays or on their storefront dedicated to a head mounted display presentation.

In some embodiments, a Supplemental Information Provider may transfer information associated with a particular location including real objects and virtual objects appearing at the particular location to an HMD. The transferred information may be used to generate an augment reality environment on the HMD. To allow for the efficient storage and exchange of virtual objects, the virtual objects may be embodied within a predetermined and standardized file format. In one example, the standardized file format may allow for portability of virtual object data between different computing platforms or devices. In some cases, the standardized file format may support state-based virtual objects by providing state information associated with different states of a virtual object (e.g., in the form of a state diagram). The states associated with a virtual object may be implemented using various data structures including directed graphs and/or hash tables.

The standardized file format may comprise a Holographic File Format. One embodiment includes the method for presenting a customized experience to a user of a personal A/V apparatus, comprising: scanning a plurality of items to create a plurality of objects in a Holographic File Format with one object created for each item, the Holographic File Format having a predetermined structure; storing the objects in the Holographic File Format for an identity; connecting a personal A/V apparatus to a local server using a wireless connection; providing the identity from the personal A/V apparatus to the local server; using the identity to access and download at least a subset of the objects to the local server; accessing data in the objects based on the predetermined structure of the Holographic File Format; and using the data to add a virtual graphic to a see-through display of the personal A/V apparatus.

One example implementation of the Holographic File Format can be used with respect to the processes of FIGS. 6A and 6B. In the method of FIG. 6A, the user, the user's home, and the user's possessions may be scanned and information from the scanning stored in the user's profile as one or more objects. In one implementation, the information is stored in the profile in the Holographic File Format as one or more objects. This way, when the user enters a sales location and the associated Supplemental Information Provider local at the sales location accesses objects in the database, those objects will be accessed in the Holographic File Format. In this way, the Supplemental Information Provider will have prior knowledge of the file format of the objects so that the objects can be efficiently used. The use of this Holographic File Format may allow developers to more easily create systems and platforms that can make use of these data so that more experiences can be customized using the personal A/V apparatus.

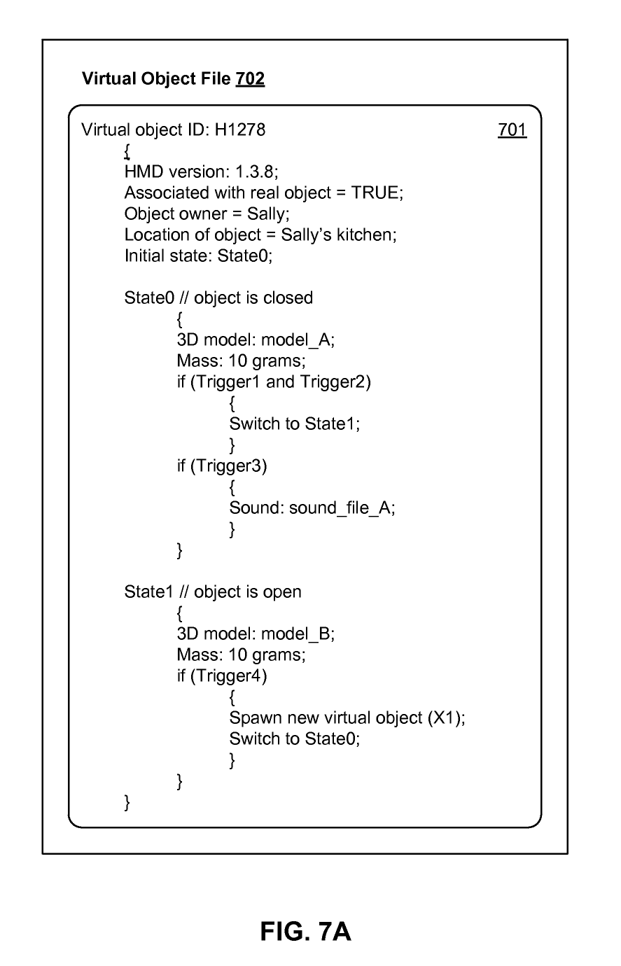

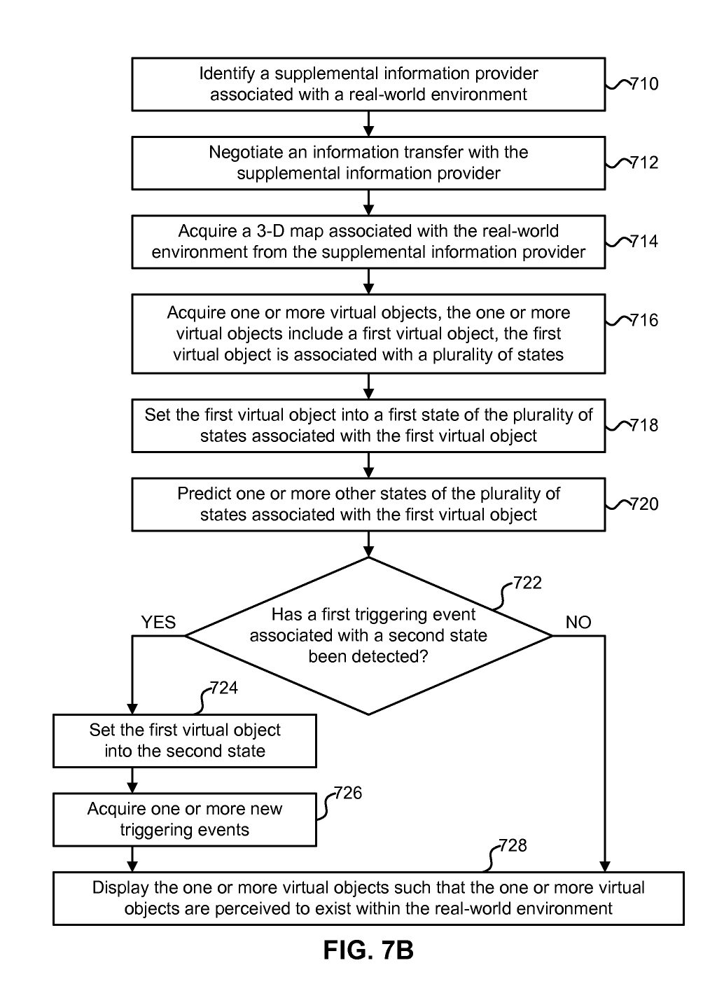

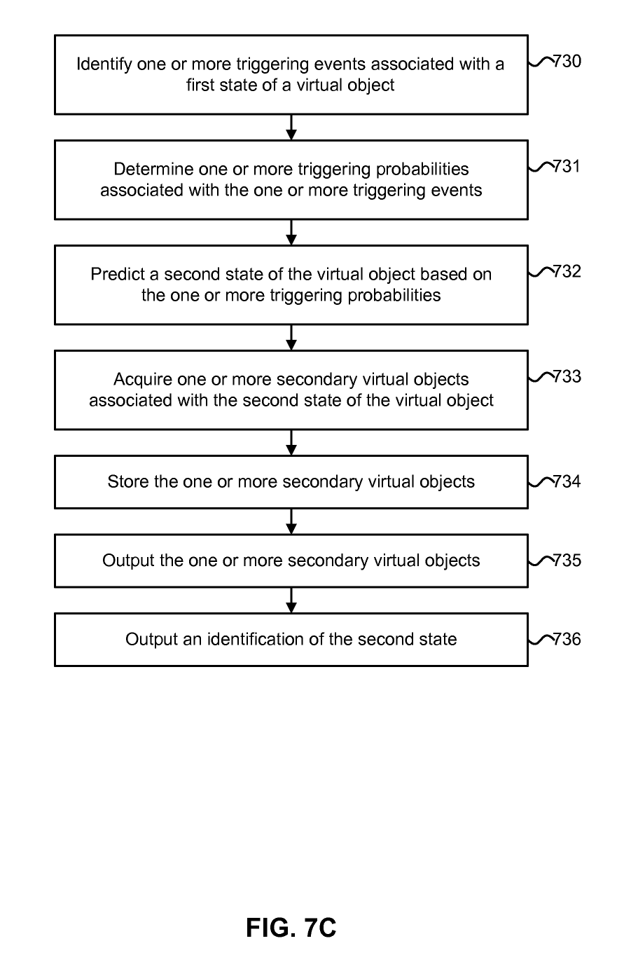

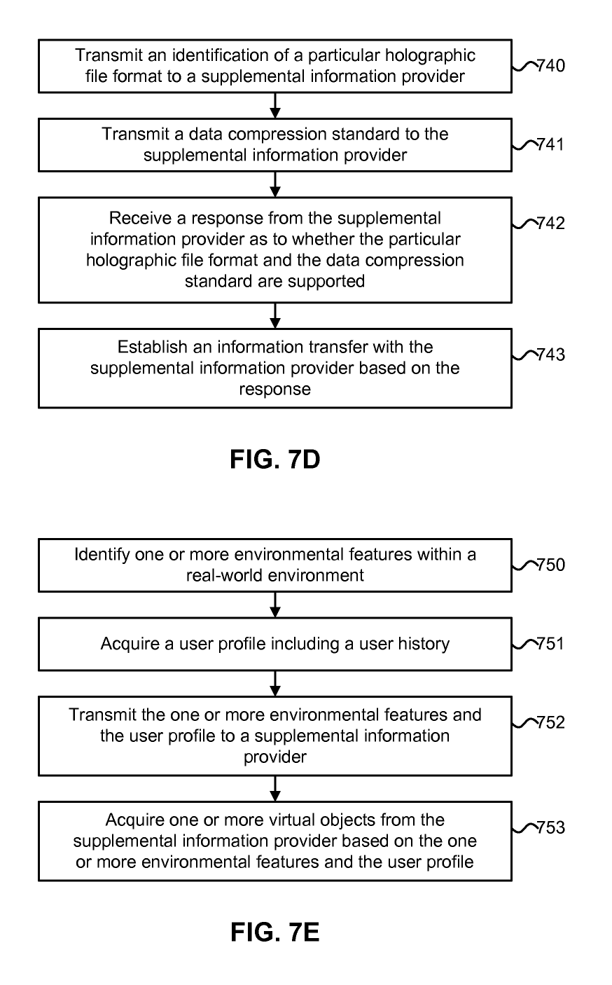

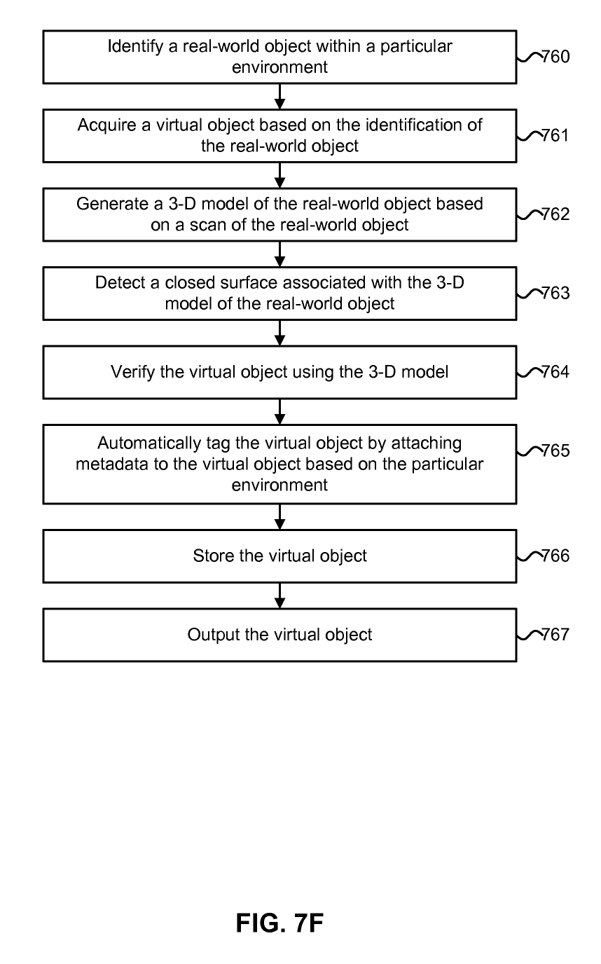

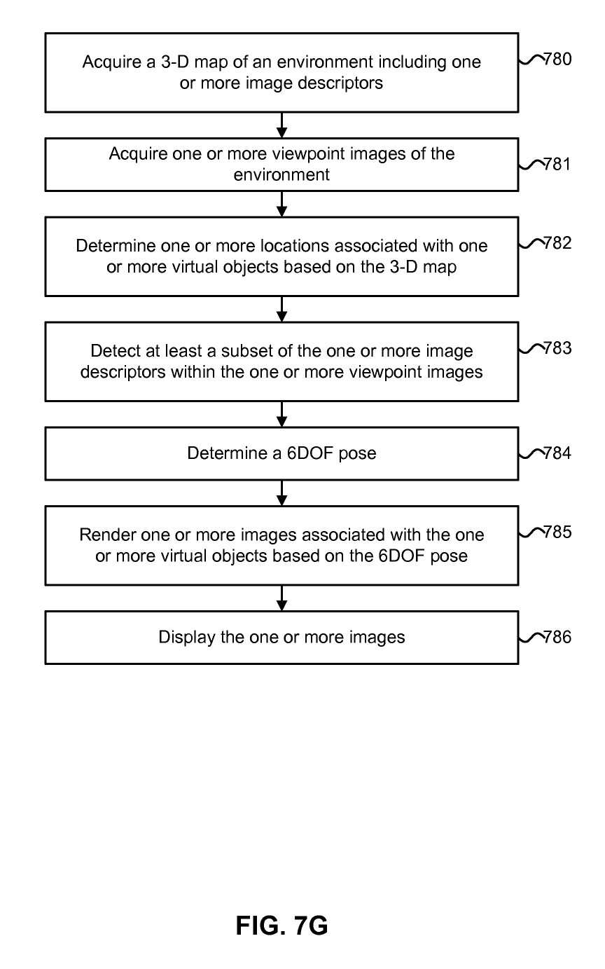

FIG. 7A depicts one embodiment of a virtual object file 702 including virtual object information associated with one or more virtual objects. As depicted, virtual object file 702 includes virtual object information 701 for generating a virtual object with a virtual object identifier (or ID) of “H1278.” The virtual object information 701 includes an HMD version field for specifying HMD system compatibility (e.g., HMD system version 1.3.8), an identification of whether the virtual object is associated with a real object, an owner of the real object associated with the virtual object (e.g., Sally), and a location of the real object (e.g., Sally's kitchen). Other tags or fields (not shown) may include when and where the virtual object information was acquired, and object descriptions such as “home furniture” or “kitchen appliance.” Virtual object information 701 may also include an identification of an initial state for the virtual object (e.g., State0).

Virtual object information 701 includes information for different states including “State0” and “State1.” In one example, “State0” may be associated with the virtual object in a closed state (e.g., a virtual box is closed) and “State1” may be associated with the virtual object in an open state (e.g., a virtual box is open). In “State0,” the virtual object is associated with a 3-D model (i.e., model_A) and an object property (e.g., Mass). The mass object property may be used to determine momentum and velocity calculations when the virtual object interacts with real objects or other virtual objects. Other object properties may also be used (e.g., object reflectivity and/or transparency). In “State1,” the virtual object is associated with a different 3-D model (i.e., model_B) than the 3-D model associated with “State0.” In one example, model_B may correspond with a deformed version of the virtual object (e.g., the virtual object is bent or distorted).

As depicted, “State0” corresponds with a unique set of triggering events different from those of “State1.” Triggering events associated with a particular state may be used to determine when a state change from the particular state is required. While in “State0,” the virtual object may transition into a different virtual object state (i.e., “State1”) if two requirements are met (i.e., if both Trigger1 and Trigger2 are detected). In one example, Trigger1 may correspond with the detection of a particular gesture and Trigger2 may correspond with the detection of a particular voice command. In another example, the triggering event may correspond with the detection of a particular hand gesture simultaneous with an eye gaze towards the virtual object. Once the triggering event is detected, then the virtual object will transition to “State1.” It should be noted that the detection of Trigger3 does not cause the virtual object to transition into a different state, instead, only a sound (e.g., based on sound_file_A) is played associated with the virtual object. In some cases, the triggering event may be detected using eye tracking techniques such as those utilized in reference to HMD 2 of FIGS. 2C-2D, or gesture recognition and/or audio recognition techniques such as those utilized in reference to computing system 10 in FIG. 4.

While in “State1,” the virtual object may transition back into “State0” if a unique triggering event occurs (i.e., if Trigger4 is detected). In one example, Trigger4 may correspond with the detection of a particular interaction occurring to the virtual object (e.g., the virtual object is hit by another virtual object). In this case, once the triggering event is detected, then the virtual object will transition back to “State0.” Also, once the triggering event is detected, a new virtual object may be generated or spawned (e.g., X1). For example, when a virtual box is opened, a new virtual object may be created such as the virtual monster 17d in FIG. 3E.

In some embodiments, virtual object information associated with a particular virtual object may include information regarding the true physical size of an object (i.e., the actual real-world size of the real object from which the particular virtual object is based). The virtual object information may also specify physical characteristics of the particular virtual object such as whether the particular virtual object is deformable or squeezable. The physical characteristics may also include a weight or mass associated with particular virtual object. The virtual object information may also specify lighting properties associated with the particular virtual object such as color of any light emitted (or reflected) from the particular virtual object, and translucency and reflectivity of the particular virtual object. The virtual object information may also specify particular sounds associated with the particular virtual object when the particular is interacted with. In some embodiments, the virtual object information regarding lighting properties, interactive sound properties, and physical characteristics may depend on a particular state of a virtual object.

FIG. 7B is a flowchart describing one embodiment of a process for generating an augmented reality environment. The augmented reality environment may utilize one or more state-based virtual objects. In one embodiment, the process of FIG. 7B is performed by a mobile device, such as mobile device 19 in FIG. 1.

In step 710, a supplemental information provider associated with a real-world environment is identified. The supplemental information provider may be detected and identified once it is within a particular distance of an HMD or it may be identified via a pointer or network address to the supplemental information provider. In step 712, an information transfer with the supplemental information provider is negotiated. The information transfer may occur using a particular protocol and may involve the transfer of files of a particular type (e.g., virtual object files using a Holographic File Format). An HMD and the supplemental provider may also negotiate which way the information transfer will take place and what type of information will be transferred. In one example, an HMD may provide the supplemental information provider with location information associated with the HMD and the supplemental information provider may transmit to the HMD one or more files providing virtual object information associated with the location information.

In step 714, a 3-D map associated with the real-world environment is acquired from the supplemental information provider. In step 716, one or more virtual objects are acquired. The one or more virtual objects may be acquired via the virtual object information supplied by the supplemental information provider. In some cases, the one or more virtual objects may be pre-stored on an HMD and pointed to by virtual object information acquired from the supplemental information provider. The one or more virtual objects may include a first virtual object associated with a plurality of different states. Each state of the plurality of different states may correspond with a unique set of triggering events different from those of any other state. The set of triggering events associated with a particular state may be used to determine when a state change from the particular state is required.

In step 718, the first virtual object is set into a first state of the plurality of different states. In step 720, one or more other states of the plurality of different states associated with the first virtual object may be predicted. In one example, triggering probabilities may be determined for each of the one or more other states relative to the first state. A triggering probability provides a probability or likelihood that another state will be reached from the current state of a virtual object. For example, a second state of the plurality of different states may be predicted if a triggering probability associated with the second state is above a particular threshold. If a state is predicted, virtual object information associated with the predicted state may be prefetched and stored on an HMD for future use.

In step 722, it is determined whether a first triggering event associated with a second state of the plurality of states has been detected. In one embodiment, the first triggering event is associated with the detection of a particular hand gesture simultaneous with an eye gaze towards the first virtual object as perceived using an HMD. In some cases, the first triggering event may be detected if an interaction from either another virtual object or a real object is above a particular virtual force threshold. The triggering events (or state change requirements) may also be based on physiological characteristics of an end user wearing an HMD. For example, heart rate information and eye movements and/or pupil dilations associated with the end user may be used to infer that the end user is sufficiently scared to warrant a triggering event.

In step 724, the first virtual object is set into the second state. In step 726, one or more new triggering events are acquired. The one or more new triggering events may be acquired from a supplemental information provider. The one or more new triggering events may be pre-stored on an HMD prior to setting the first virtual object into the second state. The one or more new triggering events may be loaded onto the HMD whereby the HMD looks for and detects interactions associated with the one or more new triggering events instead of the one or more triggering events associated with the first state. In step 728, the one or more virtual objects are displayed such that the one or more virtual objects are perceived to exist within the real-world environment. In one example, the one or more virtual objects are displayed using an HMD.

FIG. 7C is a flowchart describing one embodiment of a process for predicting future virtual object states. The process described in FIG. 7C is one example of a process for implementing step 720 in FIG. 7B. In one embodiment, the process of FIG. 7C is performed by a mobile device, such as mobile device 19 in FIG. 1.

In step 730, one or more triggering events associated with a first state of a virtual object are identified. In one embodiment, an HMD generates a state machine in which a current state of the first virtual object may be transitioned into a different state based the on one or more triggering events associated with the current state. In step 731, one or more triggering probabilities associated with the one or more triggering events are determined. The one or more triggering probabilities may be determined based on an end user's history using an HMD, generic probabilities (i.e., not specific to the end user) associated with commonly detected triggering events, and the detection rate associated with particular gestures during runtime of an augmented reality application running on the HMD. In some cases, virtual object state prediction may be performed by a server, such as a supplemental information provider within a particular distance of an HMD.

In step 732, a second state of the virtual object is predicted based on the one or more triggering probabilities determined in step 731. In one embodiment, a second state is predicted if a triggering probability associated with the second state is above a particular threshold (e.g., there is a 90% chance that a triggering event associated with the second state will be triggered). In step 733, one or more secondary virtual objects associated with the second state are acquired. In step 734, the one or more secondary virtual objects are stored. The one or more secondary virtual objects may be stored or cached on an HMD and retrieved if the virtual object is transitioned into the second state. In step 735, the one or more secondary virtual objects are outputted. In one embodiment, the one or more secondary virtual objects may be transmitted from a supplementary information provider to an HMD. In step 736, an identification of the second state is outputted. In one embodiment, the identification of the second state may be transmitted from a supplementary information provider to an HMD.

FIG. 7D is a flowchart describing one embodiment of a process for negotiating an information transfer with a supplemental information provider. The process described in FIG. 7D is one example of a process for implementing step 712 in FIG. 7B. In one embodiment, the process of FIG. 7D is performed by a mobile device, such as mobile device 19 in FIG. 1.

In step 740, an identification of a particular holographic file format is transmitted to a supplemental information provider. The particular holographic file format may comprise a standardized file format including virtual object information associated with one or more virtual objects. In step 741, a data compression standard is transmitted to the supplemental information provider. The data compression standard may be used in order to compress the size of file being transferred from the supplemental information provider to an HMD. In step 742, a response from the supplemental information provider as to whether the particular holographic file format and the data compression standard are supported is received. In one embodiment, an HMD may receive the response and determine whether or not to establish an information transfer with the supplemental information provider. In step 743, an information transfer with the supplemental information provider is established based on the response.

FIG. 7E is a flowchart describing one embodiment of a process for acquiring one or more virtual objects from a supplemental information provider. The process described in FIG. 7E is one example of a process for implementing step 716 in FIG. 7B. In one embodiment, the process of FIG. 7E is performed by a mobile device, such as mobile device 19 in FIG. 1.

In step 750, one or more environmental features within a real-world environment are identified. The one or more environmental features may include a location associated with the real-world environment (e.g., a particular amusement park or museum), the type of terrain associated with the real-world environment (e.g., an open field or a crowded space), and/or a weather classification associated with the real-world environment (e.g., is it cold or raining). In step 751, a user profile including a user history is acquired. The user profile may describe particular characteristics of an end user of an HMD such as the end user's age. The user profile may specify user preferences associated with an augmented reality environment such as limits on the number of virtual objects displayed at a particular time or the types or virtual objects that are preferred to be displayed on the HMD. The user profile may also specify permissions associated with what type of virtual objects may be displayed. For example, the user profile may be associated with a child and may prevent the display of virtual objects associated with particular types of advertising.

In step 752, the one or more environmental features and the user profile are transmitted to a supplemental information provider. The supplemental information provider may be detected within a particular distance of an HMD. The supplemental information provider may provide virtual objects associated with the real-world environment. For example, the real-world environment may comprise a ride at an amusement park or an exhibit at a museum. In step 753, one or more virtual objects are acquired from the supplemental information provider based on the one or more environmental features and the user profile.

FIG. 7F is a flowchart describing one embodiment of a process for acquiring one or more virtual objects. The process described in FIG. 7F is one example of a process for implementing step 716 in FIG. 7B. In one embodiment, the process of FIG. 7F is performed by a mobile device, such as mobile device 19 in FIG. 1.

In step 760, a real-world object is identified within a particular environment. The real-world object may be identified by an HMD using object or pattern recognition techniques. In step 761, a virtual object based on the identification of the real-world object is acquired. In one embodiment, the virtual object is acquired from a supplemental information provider by supplying an identification of the real-world object to the supplemental information provider. In some cases, more than one virtual object associated with the identification may be provided to an HMD if there is not an exact match for the identification.

In step 762, a 3-D model of the real-world object is generated based on a scan of the real-world object. The scan of the real-world object may be performed by an HMD. In step 763, a closed surface associated with the 3-D model of the real-world object is detected. In step 764, the virtual object acquired in step 761 is verified using the 3-D model created in step 762. The virtual object may be verified to check for a one to one correspondence between the shape of the virtual object and the shape of the 3-D model.

In step 765, the virtual object is automatically tagged by attaching metadata to the virtual object based on the particular environment. The metadata may be included within virtual object information associated with the virtual object. In one embodiment, the virtual object may be tagged as being owned by an end user of an HMD. The virtual object may also be tagged as being located with the home (or portion thereof) of the end user. The virtual object may be automatically tagged based on information stored in an end user profile stored on the HMD. The end user profile may provide identification information associated with the end user including a name of the end user, a work location of the end user, and a home location of the end user. In step 766, the virtual object is stored. The virtual object may be stored in non-volatile memory on the HMD. In step 767, the virtual object is outputted. The virtual object information may be retrieved from non-volatile memory on the HMD and used for generating one or more images of the virtual object.

FIG. 7G is a flowchart describing one embodiment of a process for displaying one or more virtual objects. The process described in FIG. 7G is one example of a process for implementing step 728 in FIG. 7B. In one embodiment, the process of FIG. 7G is performed by a mobile device, such as mobile device 19 in FIG. 1.

In step 780, a 3-D map of an environment is acquired. The 3-D map may include one or more image descriptors. In step 781, one or more viewpoint images of the environment are acquired. The one or more viewpoint images may be associated with a particular pose of a mobile device, such as an HMD. In step 782, one or more locations associated with one or more virtual objects are determined based on the 3-D map acquired in step 780. In one embodiment, the one or more virtual objects are registered in relation to the 3-D map. In step 783, at least a subset of the one or more image descriptors are detected within the one or more viewpoint images. The one or more image descriptors may be detected by applying various image processing methods such as object recognition, feature detection, corner detection, blob detection, and edge detection methods to the one or more viewpoint images. The one or more image descriptors may be used as landmarks in determining a particular pose, position, and/or orientation in relation to the 3-D map. An image descriptor may include color and/or depth information associated with a particular object (e.g., a red apple) or a portion of a particular object within the particular environment (e.g., the top of a red apple).

In step 784, a six degree of freedom (6DOF) pose may be determined including information associated with the position and orientation of a mobile device within the environment. In step 785, one or more images associated with the one or more virtual objects are rendered based on the 6DOF pose determined in step 784. In step 786, the one or more images are displayed such that the one or more virtual objects are perceived to exist within the environment. More information regarding registering virtual objects and rendering corresponding images in an augmented reality environment can be found in U.S. patent application Ser. No. 13/152,220, “Distributed Asynchronous Localization and Mapping for Augmented Reality,” incorporated herein by reference in its entirety.

One embodiment of the disclosed technology includes acquiring one or more virtual objects including a first virtual object. The first virtual object is associated with a first state and a second state different from the first state. The first state is associated with one or more triggering events. A first triggering event of the one or more triggering events is associated with the second state. The method further includes setting the first virtual object into the first state, detecting the first triggering event, setting the first virtual object into the second state in response to the detecting the first triggering event, and displaying on the mobile device one or more images associated with the first virtual object in the second state. The one or more images are displayed such that the first virtual object in the second state is perceived to exist within a real-world environment.

One embodiment of the disclosed technology includes acquiring one or more virtual objects from a supplemental information provider. The one or more virtual objects include a first virtual object. The first virtual object is associated with a first state and a second state different from the first state. The first state is associated with a first 3-D model and the second state is associated with a second 3-D model different from the first 3-D model. The method further includes setting the first virtual object into the first state, predicting the second state, acquiring one or more secondary virtual objects in response to the predicting the second state, detecting a first triggering event of one or more triggering events associated with the second state, setting the first virtual object into the second state in response to the detecting a first triggering event, and displaying on a mobile device one or more images associated with the first virtual object in the second state. The one or more images are displayed such that the first virtual object in the second state is perceived to exist within a real-world environment.

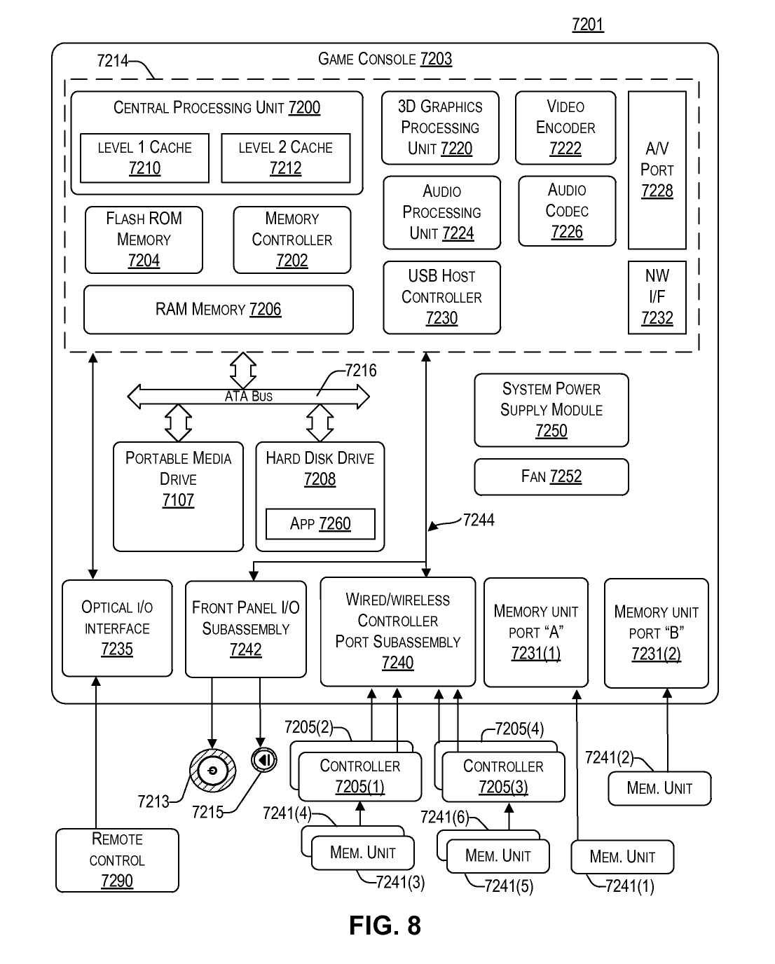

The disclosed technology may be used with various computing systems. FIGS. 8-10 provide examples of various computing systems that can be used to implement embodiments of the disclosed technology.

FIG. 8 is a block diagram of an embodiment of a gaming and media system 7201, which is one example of computing environment 12 in FIG. 3B. Console 7203 has a central processing unit (CPU) 7200, and a memory controller 7202 that facilitates processor access to various types of memory, including a flash Read Only Memory (ROM) 7204, a Random Access Memory (RAM) 7206, a hard disk drive 7208, and portable media drive 7107. In one implementation, CPU 7200 includes a level 1 cache 7210 and a level 2 cache 7212, to temporarily store data and hence reduce the number of memory access cycles made to the hard drive 7208, thereby improving processing speed and throughput.

CPU 7200, memory controller 7202, and various memory devices are interconnected via one or more buses (not shown). The one or more buses might include one or more of serial and parallel buses, a memory bus, a peripheral bus, and a processor or local bus, using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus.

In one implementation, CPU 7200, memory controller 7202, ROM 7204, and RAM 7206 are integrated onto a common module 7214. In this implementation, ROM 7204 is configured as a flash ROM that is connected to memory controller 7202 via a PCI bus and a ROM bus (neither of which are shown). RAM 7206 is configured as multiple Double Data Rate Synchronous Dynamic RAM (DDR SDRAM) modules that are independently controlled by memory controller 7202 via separate buses (not shown). Hard disk drive 7208 and portable media drive 7107 are shown connected to the memory controller 7202 via the PCI bus and an AT Attachment (ATA) bus 7216. However, in other implementations, dedicated data bus structures of different types may also be applied in the alternative.

A three-dimensional graphics processing unit 7220 and a video encoder 7222 form a video processing pipeline for high speed and high resolution (e.g., High Definition) graphics processing. Data are carried from graphics processing unit 7220 to video encoder 7222 via a digital video bus (not shown). An audio processing unit 7224 and an audio codec (coder/decoder) 7226 form a corresponding audio processing pipeline for multi-channel audio processing of various digital audio formats. Audio data are carried between audio processing unit 7224 and audio codec 7226 via a communication link (not shown). The video and audio processing pipelines output data to an A/V (audio/video) port 7228 for transmission to a television or other display. In the illustrated implementation, video and audio processing components 7220-7228 are mounted on module 7214.

FIG. 8 shows module 7214 including a USB host controller 7230 and a network interface 7232. USB host controller 7230 is in communication with CPU 7200 and memory controller 7202 via a bus (not shown) and serves as host for peripheral controllers 7205(1)-7205(4). Network interface 7232 provides access to a network (e.g., Internet, home network, etc.) and may be any of a wide variety of various wire or wireless interface components including an Ethernet card, a modem, a wireless access card, a Bluetooth® module, a cable modem, and the like.

In the implementation depicted in FIG. 8, console 7203 includes a controller support subassembly 7240 for supporting four controllers 7205(1)-7205(4). The controller support subassembly 7240 includes any hardware and software components needed to support wired and wireless operation with an external control device, such as for example, a media and game controller. A front panel I/O subassembly 7242 supports the multiple functionalities of power button 7213, the eject button 7215, as well as any LEDs (light emitting diodes) or other indicators exposed on the outer surface of console 7203. Subassemblies 7240 and 7242 are in communication with module 7214 via one or more cable assemblies 7244. In other implementations, console 7203 can include additional controller subassemblies. The illustrated implementation also shows an optical I/O interface 7235 that is configured to send and receive signals (e.g., from remote control 7290) that can be communicated to module 7214.

MUs 7241(1) and 7241(2) are illustrated as being connectable to MU ports “A” 7231(1) and “B” 7231(2) respectively. Additional MUs (e.g., MUs 7241(3)-7241(6)) are illustrated as being connectable to controllers 7205(1) and 7205(3), i.e., two MUs for each controller. Controllers 7205(2) and 7205(4) can also be configured to receive MUs (not shown). Each MU 7241 offers additional storage on which games, game parameters, and other data may be stored. Additional memory devices, such as portable USB devices, can be used in place of the MUs. In some implementations, the other data can include any of a digital game component, an executable gaming application, an instruction set for expanding a gaming application, and a media file. When inserted into console 7203 or a controller, MU 7241 can be accessed by memory controller 7202. A system power supply module 7250 provides power to the components of gaming system 7201. A fan 7252 cools the circuitry within console 7203.

An application 7260 comprising machine instructions is stored on hard disk drive 7208. When console 7203 is powered on, various portions of application 7260 are loaded into RAM 7206, and/or caches 7210 and 7212, for execution on CPU 7200. Other applications may also be stored on hard disk drive 7208 for execution on CPU 7200.

Gaming and media system 7201 may be operated as a standalone system by simply connecting the system to a monitor, a television, a video projector, or other display device. In this standalone mode, gaming and media system 7201 enables one or more players to play games or enjoy digital media (e.g., by watching movies or listening to music). However, with the integration of broadband connectivity made available through network interface 7232, gaming and media system 7201 may further be operated as a participant in a larger network gaming community.

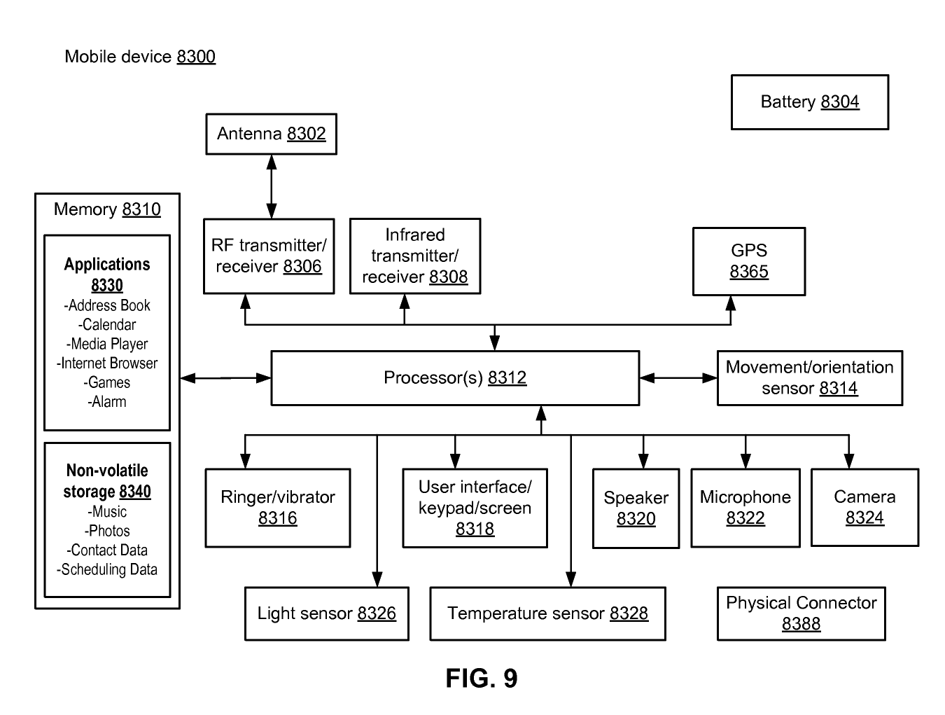

FIG. 9 is a block diagram of one embodiment of a mobile device 8300, such as mobile device 19 in FIG. 1. Mobile devices may include laptop computers, pocket computers, mobile phones, personal digital assistants, and handheld media devices that have been integrated with wireless receiver/transmitter technology.

Mobile device 8300 includes one or more processors 8312 and memory 8310. Memory 8310 includes applications 8330 and non-volatile storage 8340. Memory 8310 can be any variety of memory storage media types, including non-volatile and volatile memory. A mobile device operating system handles the different operations of the mobile device 8300 and may contain user interfaces for operations, such as placing and receiving phone calls, text messaging, checking voicemail, and the like. The applications 8330 can be any assortment of programs, such as a camera application for photos and/or videos, an address book, a calendar application, a media player, an internet browser, games, an alarm application, and other applications. The non-volatile storage component 8340 in memory 8310 may contain data such as music, photos, contact data, scheduling data, and other files.

The one or more processors 8312 also communicates with RF transmitter/receiver 8306 which in turn is coupled to an antenna 8302, with infrared transmitter/receiver 8308, with global positioning service (GPS) receiver 8365, and with movement/orientation sensor 8314 which may include an accelerometer and/or magnetometer. RF transmitter/receiver 8308 may enable wireless communication via various wireless technology standards such as Bluetooth® or the IEEE 802.11 standards. Accelerometers have been incorporated into mobile devices to enable applications such as intelligent user interface applications that let users input commands through gestures, and orientation applications which can automatically change the display from portrait to landscape when the mobile device is rotated. An accelerometer can be provided, e.g., by a micro-electromechanical system (MEMS) which is a tiny mechanical device (of micrometer dimensions) built onto a semiconductor chip. Acceleration direction, as well as orientation, vibration, and shock can be sensed. The one or more processors 8312 further communicate with a ringer/vibrator 8316, a user interface keypad/screen 8318, a speaker 8320, a microphone 8322, a camera 8324, a light sensor 8326, and a temperature sensor 8328. The user interface keypad/screen may include a touch-sensitive screen display.

The one or more processors 8312 controls transmission and reception of wireless signals. During a transmission mode, the one or more processors 8312 provide voice signals from microphone 8322, or other data signals, to the RF transmitter/receiver 8306. The transmitter/receiver 8306 transmits the signals through the antenna 8302. The ringer/vibrator 8316 is used to signal an incoming call, text message, calendar reminder, alarm clock reminder, or other notification to the user. During a receiving mode, the RF transmitter/receiver 8306 receives a voice signal or data signal from a remote station through the antenna 8302. A received voice signal is provided to the speaker 8320 while other received data signals are processed appropriately.

Additionally, a physical connector 8388 may be used to connect the mobile device 8300 to an external power source, such as an AC adapter or powered docking station, in order to recharge battery 8304. The physical connector 8388 may also be used as a data connection to an external computing device. The data connection allows for operations such as synchronizing mobile device data with the computing data on another device.

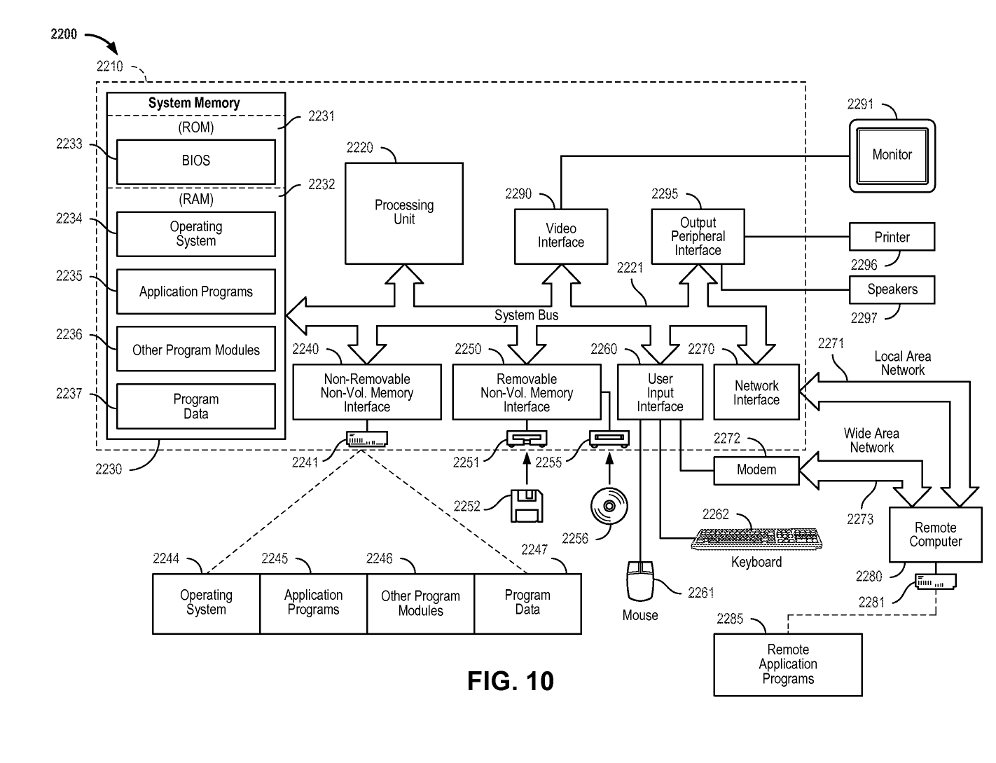

FIG. 10 is a block diagram of an embodiment of a computing system environment 2200, such as computing system 10 in FIG. 3B. Computing system environment 2200 includes a general purpose computing device in the form of a computer 2210. Components of computer 2210 may include, but are not limited to, a processing unit 2220, a system memory 2230, and a system bus 2221 that couples various system components including the system memory 2230 to the processing unit 2220. The system bus 2221 may be any of several types of bus structures including a memory bus, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 2210 typically includes a variety of computer readable media. Computer readable media can be any available media that can be accessed by computer 2210 and includes both volatile and nonvolatile media, removable and non-removable media. By way of example, and not limitation, computer readable media may comprise computer storage media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 2210. Combinations of the any of the above should also be included within the scope of computer readable media.

The system memory 2230 includes computer storage media in the form of volatile and/or nonvolatile memory such as read only memory (ROM) 2231 and random access memory (RAM) 2232. A basic input/output system 2233 (BIOS), containing the basic routines that help to transfer information between elements within computer 2210, such as during start-up, is typically stored in ROM 2231. RAM 2232 typically contains data and/or program modules that are immediately accessible to and/or presently being operated on by processing unit 2220. By way of example, and not limitation, FIG. 10 illustrates operating system 2234, application programs 2235, other program modules 2236, and program data 2237.

The computer 2210 may also include other removable/non-removable, volatile/nonvolatile computer storage media. By way of example only, FIG. 10 illustrates a hard disk drive 2241 that reads from or writes to non-removable, nonvolatile magnetic media, a magnetic disk drive 2251 that reads from or writes to a removable, nonvolatile magnetic disk 2252, and an optical disk drive 2255 that reads from or writes to a removable, nonvolatile optical disk 2256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 2241 is typically connected to the system bus 2221 through an non-removable memory interface such as interface 2240, and magnetic disk drive 2251 and optical disk drive 2255 are typically connected to the system bus 2221 by a removable memory interface, such as interface 2250.

The drives and their associated computer storage media discussed above and illustrated in FIG. 10, provide storage of computer readable instructions, data structures, program modules and other data for the computer 2210. In FIG. 10, for example, hard disk drive 2241 is illustrated as storing operating system 2244, application programs 2245, other program modules 2246, and program data 2247. Note that these components can either be the same as or different from operating system 2234, application programs 2235, other program modules 2236, and program data 2237. Operating system 2244, application programs 2245, other program modules 2246, and program data 2247 are given different numbers here to illustrate that, at a minimum, they are different copies. A user may enter commands and information into computer 2210 through input devices such as a keyboard 2262 and pointing device 2261, commonly referred to as a mouse, trackball, or touch pad. Other input devices (not shown) may include a microphone, joystick, game pad, satellite dish, scanner, or the like. These and other input devices are often connected to the processing unit 2220 through a user input interface 2260 that is coupled to the system bus, but may be connected by other interface and bus structures, such as a parallel port, game port or a universal serial bus (USB). A monitor 2291 or other type of display device is also connected to the system bus 2221 via an interface, such as a video interface 2290. In addition to the monitor, computers may also include other peripheral output devices such as speakers 2297 and printer 2296, which may be connected through an output peripheral interface 2295.

The computer 2210 may operate in a networked environment using logical connections to one or more remote computers, such as a remote computer 2280. The remote computer 2280 may be a personal computer, a server, a router, a network PC, a peer device or other common network node, and typically includes many or all of the elements described above relative to the computer 2210, although only a memory storage device 2281 has been illustrated in FIG. 10. The logical connections depicted in FIG. 10 include a local area network (LAN) 2271 and a wide area network (WAN) 2273, but may also include other networks. Such networking environments are commonplace in offices, enterprise-wide computer networks, intranets and the Internet.

When used in a LAN networking environment, the computer 2210 is connected to the LAN 2271 through a network interface or adapter 2270. When used in a WAN networking environment, the computer 2210 typically includes a modem 2272 or other means for establishing communications over the WAN 2273, such as the Internet. The modem 2272, which may be internal or external, may be connected to the system bus 2221 via the user input interface 2260, or other appropriate mechanism. In a networked environment, program modules depicted relative to the computer 2210, or portions thereof, may be stored in the remote memory storage device. By way of example, and not limitation, FIG. 10 illustrates remote application programs 2285 as residing on memory device 2281. It will be appreciated that the network connections shown are exemplary and other means of establishing a communications link between the computers may be used.

The disclosed technology is operational with numerous other general purpose or special purpose computing system environments or configurations. Examples of well-known computing systems, environments, and/or configurations that may be suitable for use with the technology include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosed technology may be described in the general context of computer-executable instructions, such as program modules, being executed by a computer. Generally, software and program modules as described herein include routines, programs, objects, components, data structures, and other types of structures that perform particular tasks or implement particular abstract data types. Hardware or combinations of hardware and software may be substituted for software modules as described herein.

The disclosed technology may also be practiced in distributed computing environments where tasks are performed by remote processing devices that are linked through a communications network. In a distributed computing environment, program modules may be located in both local and remote computer storage media including memory storage devices.

For purposes of this document, each process associated with the disclosed technology may be performed continuously and by one or more computing devices. Each step in a process may be performed by the same or different computing devices as those used in other steps, and each step need not necessarily be performed by a single computing device.

For purposes of this document, reference in the specification to “an embodiment,” “one embodiment,” “some embodiments,” or “another embodiment” are used to described different embodiments and do not necessarily refer to the same embodiment.

For purposes of this document, a connection can be a direct connection or an indirect connection (e.g., via another part).

For purposes of this document, the term “set” of objects, refers to a “set” of one or more of the objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for generating an augmented reality environment using a mobile device, comprising:
acquiring a particular file of a predetermined file format, the particular file includes information associated with one or more virtual objects, the particular file includes state information for each virtual object of the one or more virtual objects, the one or more virtual objects include a first virtual object, the first virtual object is associated with a first state and a second state different from the first state, the first state is associated with one or more triggering events, a first triggering event of the one or more triggering events is associated with the second state;
setting the first virtual object into the first state;
detecting the first triggering event;
setting the first virtual object into the second state in response to the detecting the first triggering event, the setting the first virtual object into the second state includes acquiring one or more new triggering events different from the one or more triggering events; and
generating and displaying on the mobile device one or more images associated with the first virtual object in the second state, the one or more images are displayed such that the first virtual object in the second state is perceived to exist within a real-world environment.

2. The method of claim 1, wherein:
the first state is associated with a first 3-D model of the first virtual object; and
the second state is associated with a second 3-D model of the first virtual object different from the first 3-D model, the one or more images comprise rendered versions of the second 3-D model.

3. The method of claim 2, further comprising:
displaying on the mobile device one or more other images associated with the first virtual object in the first state, the one or more other images are displayed such that the first virtual object in the first state is perceived to exist within the real-world environment, the displaying on the mobile device one or more other images associated with the first virtual object in the first state is performed prior to the detecting the first triggering event, the one or more other images comprise rendered versions of the first 3-D model.

4. The method of claim 1, wherein:
the first triggering event includes the performance of a particular hand gesture simultaneous with an eye gaze towards the first virtual object; and
the mobile device comprises a see-through HMD.

5. The method of claim 1, wherein:
the second state is associated with the one or more new triggering events different from the one or more triggering events.

6. The method of claim 1, further comprising:
predicting the second state prior to the setting the first virtual object into the second state; and
acquiring one or more secondary virtual objects in response to the predicting the second state prior to the setting the first virtual object into the second state.

7. The method of claim 6, wherein:
the predicting the second state includes determining one or more triggering probabilities associated with each of the one or more triggering events.

8. The method of claim 1, further comprising:
identifying a supplemental information provider associated with the real-world environment; and
negotiating an information transfer with the supplemental information provider, the acquiring one or more virtual objects includes acquiring the one or more virtual objects from the supplemental information provider.

9. The method of claim 8, wherein:
the negotiating an information transfer includes receiving a response from the supplemental information provider as to whether the particular file format is supported by the supplemental information provider.

10. One or more storage devices containing processor readable code for programming one or more processors to perform a method for generating an augmented reality environment comprising the steps of:
acquiring one or more virtual objects from a supplemental information provider, the one or more virtual objects include a first virtual object, the first virtual object is associated with a first state and a second state different from the first state, the first state is associated with a first 3-D model, the second state is associated with a second 3-D model different from the first 3-D model;
setting the first virtual object into the first state, the first state is associated with one or more triggering events;
predicting the second state, the predicting the second state includes determining one or more triggering probabilities associated with each of the one or more triggering events;
acquiring one or more secondary virtual objects in response to the predicting the second state;
detecting a first triggering event of the one or more triggering events associated with the second state;
setting the first virtual object into the second state in response to the detecting a first triggering event; and
generating and displaying on a mobile device one or more images associated with the first virtual object in the second state, the one or more images are displayed such that the first virtual object in the second state is perceived to exist within a real-world environment.

11. The one or more storage devices of claim 10, wherein:
the one or more images comprise rendered versions of the second 3-D model.

12. The one or more storage devices of claim 10, wherein:
the second 3-D model comprises a deformed version of the first virtual object.

13. The one or more storage devices of claim 10, further comprising:
displaying on the mobile device one or more other images associated with the first virtual object in the first state, the one or more other images are displayed such that the first virtual object in the first state is perceived to exist within the real-world environment, the displaying on the mobile device one or more other images associated with the first virtual object in the first state is performed prior to the detecting a first triggering event, the one or more other images comprise rendered versions of the first 3-D model.

14. The one or more storage devices of claim 10, wherein:
the first triggering event includes at least one of the performance of a particular physical gesture, the performance of an eye gaze towards the first virtual object for at least a particular period of time, or the performance of a particular voice command; and
the mobile device comprises a see-through HMD.

15. The one or more storage devices of claim 10, wherein:
the second state is associated with one or more new triggering events different from the one or more triggering events.

16. The one or more storage devices of claim 10, further comprising:
identifying the supplemental information provider; and
negotiating an information transfer with the supplemental information provider, the negotiating an information transfer includes receiving a response from the supplemental information provider as to whether a particular holographic file format is supported by the supplemental information provider.

17. An electronic device for generating an augmented reality environment, comprising:
one or more processors, the one or more processors establish a connection with a supplemental information provider, the one or more processors transmit a particular identity associated with one or more virtual objects to the supplemental information provider, the one or more processors receive virtual object information associated with the one or more virtual objects based on the particular identity, the virtual object information is embedded within a particular file of a particular holographic file format, the particular holographic file format comprises a predetermined structure, the one or more virtual objects include a first virtual object, the one or more processors determine a pose associated with the electronic device, the one or more processors generate one or more images associated with the first virtual object based on the pose; and
a see-through display, the see-through display displays the one or more images associated with the first virtual object, the one or more images are displayed such that the first virtual object is perceived to exist within a real-world environment in which the electronic device exists.

18. The electronic device of claim 17, wherein:
the first virtual object is associated with a first state and a second state different from the first state, the first state is associated with one or more triggering events, a first triggering event of the one or more triggering events is associated with the second state, the one or more processors set the first virtual object into the first state, the one or more processors detect the first triggering event, the one or more processors set the first virtual object into the second state in response to the detection of the first triggering event, the one or more processors acquire one or more new triggering events from the supplemental information provider different from the one or more triggering events in response to the detection of the first triggering event, the one or more images are associated with the first virtual object in the second state, the one or more images are displayed such that the first virtual object in the second state is perceived to exist within the real-world environment.

19. The electronic device of claim 18, wherein:
the first state is associated with a first 3-D model of the first virtual object; and
the second state is associated with a second 3-D model of the first virtual object different from the first 3-D model.

20. The electronic device of claim 18, wherein:
the first triggering event includes the performance of a particular hand gesture simultaneous with an eye gaze towards the first virtual object; and
the electronic device comprises a see-through HMD.
